(19) United States
(12) Patent Application Publication
(10) Pub. No.: US 2018/0034657 A1
(43) Pub. Date: Feb. 1, 2018

(54) Method and System of Monitoring Appliance Usage

(71) Applicant: Energy Technologies Institute LLP, Loughborough, Leicestershire (GB)

(72) Inventors: Roger Warwick BROWN, Coleshill (GB); Andrew Michael HASLETT, Heswall (GB)

(73) Assignee: Energy Technologies Institute LLP, Loughborough, Leicestershire (GB)

(21) Appl. No.: 15/552,087

(22) PCT Filed: Feb. 24, 2016
(86) PCT No.: PCT/GB2016/050460

§ 371 Date: Aug. 18, 2017

(30) Foreign Application Priority Data
Feb. 24, 2015 (GB) 1503042.2

(51) Int. Cl. H04L 12/28; G06Q 10/06; G06F 9/44; G06Q 50/06

(52) U.S. Cl. CPC H04L 12/2823; G06Q 50/06; G06Q 10/0633; G06F 9/444

(57) ABSTRACT

A method of operating an environment management system within a building, comprises: monitoring appliance usage within the building by monitoring two or more utilities and measuring one or more characteristics relating to each of the utilities to provide an output signal representative thereof; monitoring for changes in the state of each of the output signals at predefined time intervals; combining data from the output signals from each utility, to identify one or more patterns of appliance usage; comparing the identified pattern of appliance usage with stored patterns of appliance usage associated with individual occupants of the building to identify an expected pattern of future appliance usage; and operating the environment management system to control the environment in the building in accordance with the identified expected pattern of future appliance usage.

### TECHNICAL FIELD

The present invention relates to a method and system of monitoring appliance usage within a building.

### BACKGROUND TO THE INVENTION

There are many devices or appliances in dwellings, from individual light fittings, through televisions to major energy users, such as boilers and tumble dryers. In future, some of these devices may be smart, so that they declare their presence and their status can be read, including the possibility of control, such as turning lights on and off to discourage burglars, scheduling drying when power is cheap etc. Some devices will already have this capability (such as Smart TVs and heating systems), although most do not. Understanding patterns of occupancy, appliance use and utility consumption in dwellings currently requires unaffordable levels of instrumentation. Although sensors may eventually be embedded in all devices, including lighting, the timescale for it to be normal to find this level of embedded sensors in the domestic environment is likely to be significantly in excess of fifteen years. Buildings environmental management is a key element in future utility supply and use, both in terms of energy efficiency, costs budgeting and improving user control and experience.

The existence and usage of appliances within a building can be recognised by inference from their utility usage signatures. The principles for this have been described in U.S. Pat. No. 4,858,141 and are now encompassed within a community of practitioners of Non-Intrusive Appliance Load Measurement (NIALM) for example, as described in “Is Disaggregation The Holy Grail Of Energy Efficiency? The Case Of Electricity”, K. Carrie Armel, Abhay Gupta, Gireesh Shrimali and Adrian Albert, Energy Policy, 2013, vol. 52, issue C, pp 213-234. While the concepts of this technology have been recognised for some time, its application in practice has been limited by a failure to integrate various elements effectively into a practical solution. In U.S. Pat. No. 4,858,141, and other subsequent publications, data is gathered from electric power usage measurements. Using data from utilities other than electricity, and taking additional factors/data into account, has been touched on by various sources, some of them in U.S. Pat. No. 4,858,141. However, the prior art neither teaches how these concepts should be implemented individually and in effective combinations, nor how they should form part of an effective overall Building Environment Management System (BEMS).

The present invention has therefore been designed with the foregoing in mind.

### SUMMARY OF THE INVENTION

Monitoring appliance usage is central to the effective operation of a Building Environment Management System (BEMS). Not only does it provide data about energy usage, but more importantly it provides information about patterns of activity and use of the building by the occupants which can enable the BEMS to better manage the building environment to fit with these patterns of occupation. Nowhere is this more true than for a Home Environment Management System (HEMS). People spend more time at home than in any other building; they show the widest range of activity patterns at home; and they expect to have the most control over their domestic environment. Implementing appliance monitoring on its own will provide information on patterns of utility use. Integrating it into a HEMS will enable information about patterns of occupancy to be used, for example in scheduling a heating system. Also the HEMS can provide additional information to an appliance usage module, for example, that a temperature rise in a living room is consistent with a gas fire being in operation. The prior art does not discuss or teach about the implementation of these functionalities in any coherent way.

For the sake of brevity, the specification tends to refer to a HEMS only. It should be understood that the invention can also be applied to any BEMS, not just a HEMS.

According to a first aspect of the present invention there is defined a method of operating an environment management system within a building as defined in claim 1. The method comprises: monitoring appliance usage by monitoring two or more utilities and measuring one or more characteristics relating to each of the utilities to provide an output signal representative thereof; monitoring for changes in the state of each of the output signals at predefined time intervals; combining data from the output signals from each utility, to identify one or more patterns of appliance usage; comparing the identified pattern of appliance usage with stored patterns of appliance usage associated with individual occupants of the building to identify an expected pattern of future appliance usage; and operating the environment management system to control the environment in the building in accordance with the identified expected pattern of future appliance usage.

The invention enables complex patterns of utility usage to be used to extract information on what appliances are present within a building and the activities of a person or persons within the building whilst those utilities are being utilised. Advantageously, the method enables deduction of appliance usage patterns, and identification or recognition of appliances or the state of appliances, in a relatively inexpensive way. This is because a low cost set of measurements on utilities at the point of entry into a building can replace or enhance what would otherwise be a much higher number of sensors distributed around the building and its appliances and systems. This in turn adds value to consumers in assisting them to manage their energy use effectively.

Using more information obtained from monitoring the utilities can allow more details to be determined about the patterns of occupation in the building (i.e. identifying a light switch signature alone would not allow the location of the light to be determined without taking into account other factors—e.g. a tap is running in the bathroom early in the morning so the light is likely to be in the bathroom). Monitoring more than one utility (e.g. electricity and water and possibly also gas) therefore helps to determine which appliances are being used based on expected or probable patterns of appliance usage.

The patterns of appliance usage might comprise recognising that a particular appliance is used at a particular time of day/week (e.g. a washing machine is always operated on a Monday, or a user always fills and boils a kettle when they arrive home after work).

If a single instance of utility usage is considered in isolation (as is the case in the prior art) it is not always possible to determine the appliance in question. For example, a similar amount of water may be used when flushing a toilet and when washing hands. In which case, prior art methods will be unable to distinguish between these two activities. By contrast, the present invention can use additional information (e.g. a noise signal) to distinguish between the sound of a tap valve opening and the sound of a flush valve opening to determine which appliance is being used.

It is possible to identify operation of a motor because it will have a phase angle associated with its use.

Operation of a dishwasher may be distinguished from a washing machine due to the presence of a drying cycle (comprising heating without water usage) in only the dishwasher and/or the presence of a spin cycle (comprising a motor without water usage) in only the washing machine.

The two or more utilities may comprise water and electricity. Gas may be monitored instead of or in addition to electricity. Other utilities may also be monitored.

The step of identifying patterns of appliance usage may comprise using a priori probabilities and firstly comparing reference patterns of appliance usage that are determined to be most likely, with the data. For example, if water is flowing first thing in the morning at the same time as a pump is running, the system may hypothesise that an occupant is having a shower.

Appliances in the building may constitute a system and the system may be represented as a finite state machine and each output signal may represent a state of a characteristic of the system at a particular time.

According to a second aspect of the present invention there is defined a method of operating an environment management system within a building as defined in claim 4. The method comprises: monitoring appliance usage within a building, wherein appliances in the building constitute a system and the system is represented as a finite state machine; monitoring two or more utilities and measuring one or more characteristics relating to each of the utilities to provide an output signal, each output signal representing a state of a characteristic of the system at a particular time; monitoring for changes in the state of each of the output signals at predefined time intervals; combining data from the output signals from each utility, to identify one or more patterns of appliance usage; and operating the environment management system to control the environment in the building in accordance with the identified patterns.

In embodiments of the first or second aspects, the system may be represented as a Markov chain.

The measurement of said one or more characteristics may be recorded within a measurement bin of predetermined size, said bin being within a predetermined measurement range.

The method may further comprise defining a work process based on a pattern of inputs to an appliance over time.

The method may comprise defining a work flow based on identifiable sequences of work processes across one or more appliances.

The step of identifying one or more patterns of appliance usage comprises determining a utility usage pattern for an appliance based on processing of said output signals and analysis of identified work processes and work flows.

The method may comprise comparing one or more of said patterns of appliance usage with one or more reference patterns to identify the appliance with which the output signals are associated.

The method may comprise evaluating the probability that an appliance exists within the building based on said comparison.

The method may comprise comparing one or more of said patterns of appliance usage with one or more reference patterns to infer an indication of the existence, location and/or usage of one or more appliances within said building.

The a priori probabilities may include frequency distributions of work flows.

The a priori probabilities may include exogenous factors and hypotheses about the occupation state of the building.

The method may further comprise modifying the a priori probabilities associated with patterns of appliance usage hypothetically arising from work flow(s), work process(es), appliance(s) and/or component(s) of appliance(s) by reference to stored data on historic appliance usage.

The historic appliance usage may relate to one or more appliances in one or more other buildings and the a priori probabilities may be determined dependent on the geographical distance of another building relative to the said building.

The method may further comprise representing one or more reference appliances in a computer language whereby the pattern of appliance usage is derived from defined processes operating on defined components within the appliance.

The language may enable specific instances of appliances, processes and components to be created by class inheritance.

The reference appliance pattern may be acquired from an electronic signature, barcode or Qcode present on or related to said appliance.

The probabilities may be derived from a combination of analysis of central data and user input.

The characteristics may comprise one or more of flow variables, noise variables or quality variables.

The characteristics may comprise one or more of voltage, RMS voltage, calorific value, phase angle, power, real power, reactive power and colour.

According to a third aspect of the invention there is provided an apparatus for operating an environment management system within a building, comprising apparatus for monitoring appliance usage within the building, comprising a plurality of measurement devices, each configured to measure one or more characteristics relating to a particular one of two or more utilities and to provide an output signal representative thereof; and a processing device configured, in response to the combination of said output signals from each utility, to: monitor for changes in the state of each of said output signals at predefined time intervals and combine information from a plurality of output signals to identify one or more patterns of appliance usage; to compare the identified pattern of appliance usage with stored patterns of appliance usage associated with individual occupants of the building to identify an expected pattern of future appliance usage; and to operate the environment management system to control the environment in the building in accordance with the identified expected pattern of future appliance usage.

According to a fourth aspect of the invention there is provided an apparatus for operating an environment management system within a building, comprising: apparatus for monitoring appliance usage within the building, comprising a plurality of measurement devices, each configured to measure one or more characteristics relating to a particular one of two or more utilities and to provide an output signal representative thereof; and a processing device configured, in response to the combination of said output signals from each utility, to: monitor for changes in the state of each of said output signals at predefined time intervals and combine information from a plurality of output signals to identify one or more patterns of appliance usage, wherein appliances in the building constitute a system and the system is represented as a finite state machine, each output signal representing a state of a characteristic of the system at a particular time; and to operate the environment management system to control the environment in the building in accordance with the identified patterns.

Advantageously, aspects of the invention enables inference of appliance existence/usage within a building based on combining multiple signals relating to different utilities and, more specifically, to different components or characteristics of the different utilities.

Ideally, components of appliances will be manufactured so that a probability distribution of their utility usage signatures will be large enough and well-distributed enough to maximise the chance of disambiguation by the HEMS. If the distribution is known and supplied by the manufacturer, it can be used by the HEMS as an input to the disambiguation process for identifying appliances, either where the component parameter values are measured, and supplied together with the range, or where the range alone is supplied with the component. Furthermore, appliances are ideally assembled using components where the parameters of the work processes (for example exact duration of a step in a wash cycle) are sufficiently distinct to increase disambiguation in a similar manner to the above.

In effect, aspects of the invention relate to a HEMS that assesses the state of the entire system at regular points in time and tries to determine what is happening. This may include determining what components are being used, what appliances are being used, what work processes are being used and what work flows are in operation. In other words, the system uses utility data to accurately build up a real-time picture of the activities being undertaken in the building at any point in time and may use this to predict a work flow so that the likely energy usage can be supplied. This is contrary to the prior art which relies on nice clean step changes from single utility measurements to identify individual appliances.

In addition, the HEMS may conduct a historical review (or calibration process) to consider the utility usage signatures for unidentified components, appliances, work processes or work flows and to hypothesis about what these might be. The historical review may be programmed to run at regular intervals and/or whenever a new component, appliance, work process or work flow is encountered. The historical review may compare data with that from other HEMS, particularly from buildings geographically close to the building concerned.

### BRIEF DESCRIPTION OF EMBODIMENTS OF THE INVENTION

Embodiments of the invention will now be described, by way of example only, with reference to the Figures of the accompanying drawings in which:

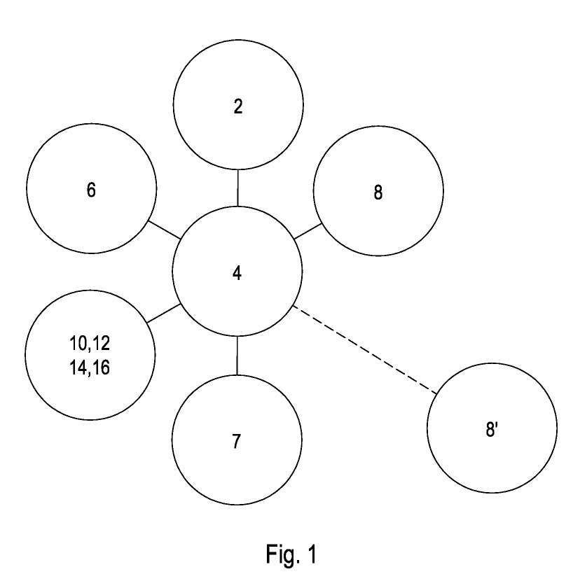

FIG. 1 shows a schematic representation of an appliance recognition unit in use with a HEMS;

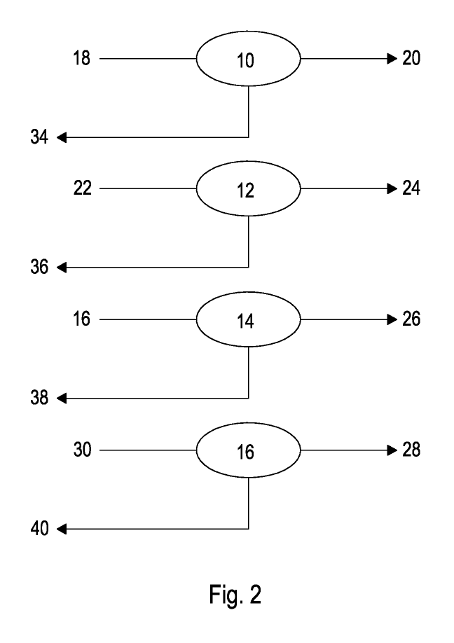

FIG. 2 shows a schematic representation of utility measurement;

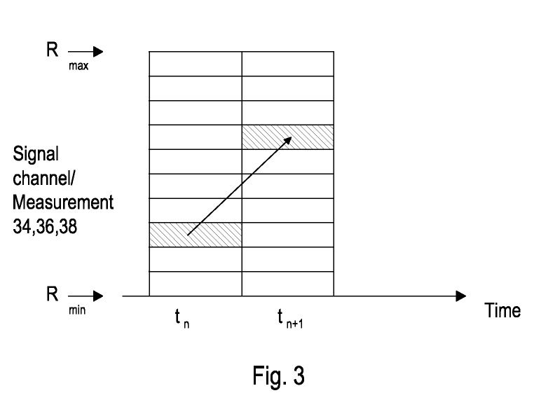

FIG. 3 is a schematic representation of a finite state analysis of a utility signal channel;

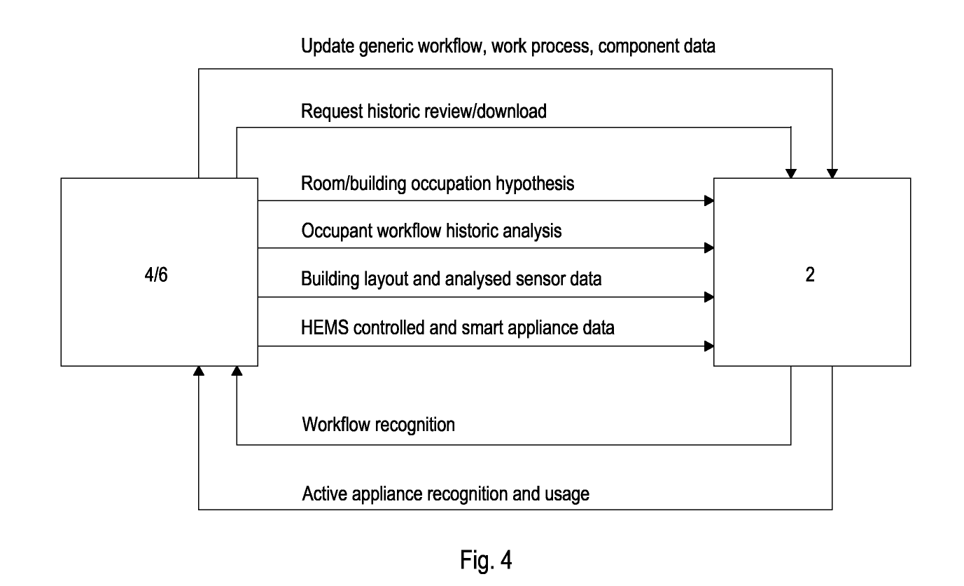

FIG. 4 is a schematic view of communications between the appliance recognition unit and other modules in a HEMS;

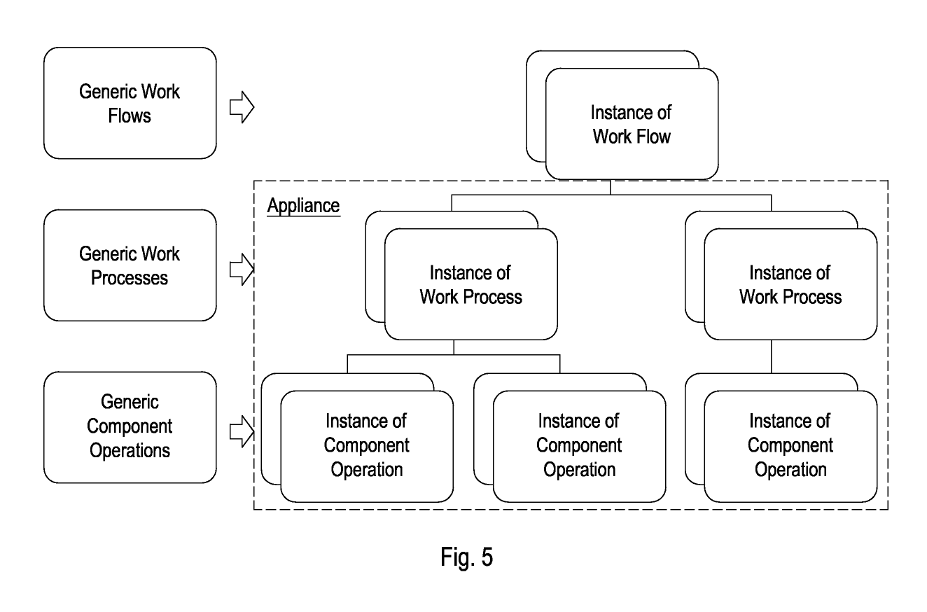

FIG. 5 is an overview of the hierarchy of appliance operation;

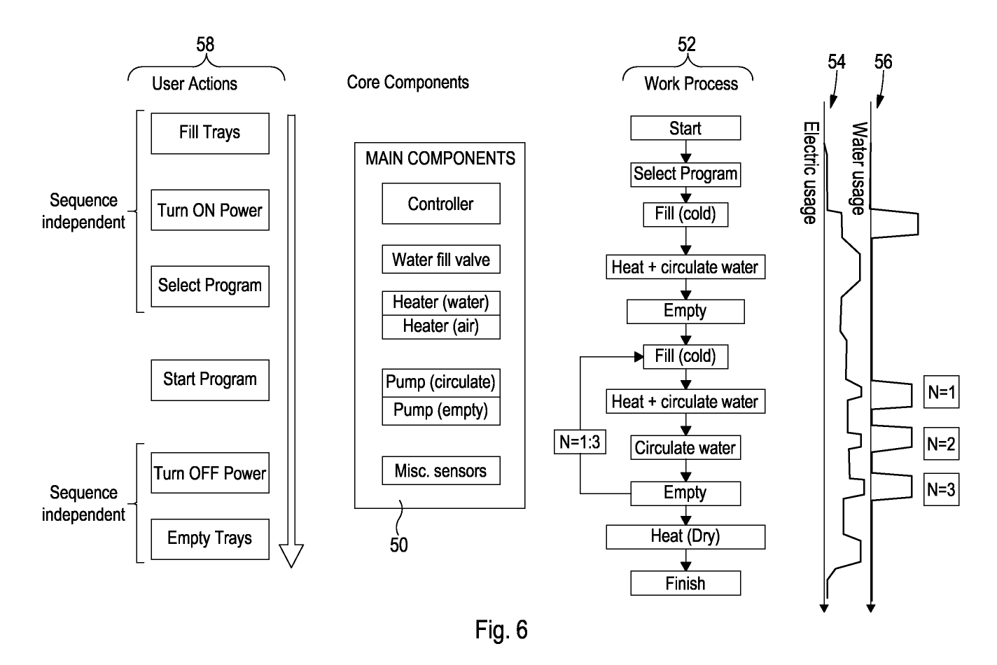

FIG. 6 illustrates work processes and components in a generic dishwasher;

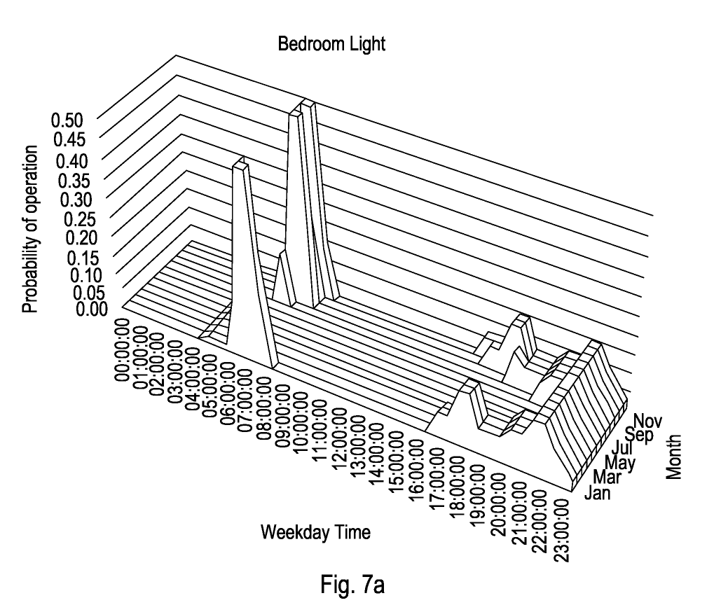

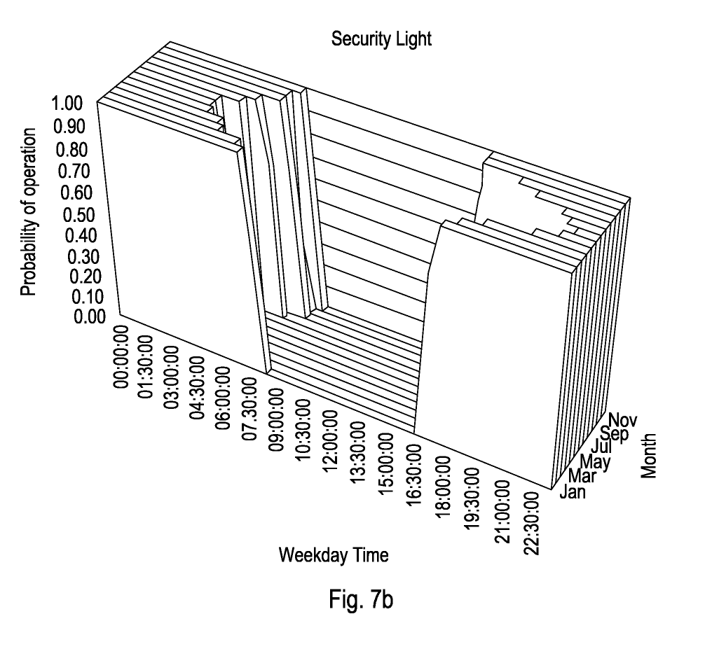

FIG. 7a is a graphical representation of daily operation of a bedroom light by month;

FIG. 7b is a graphical representation of daily operation of a security light by month;

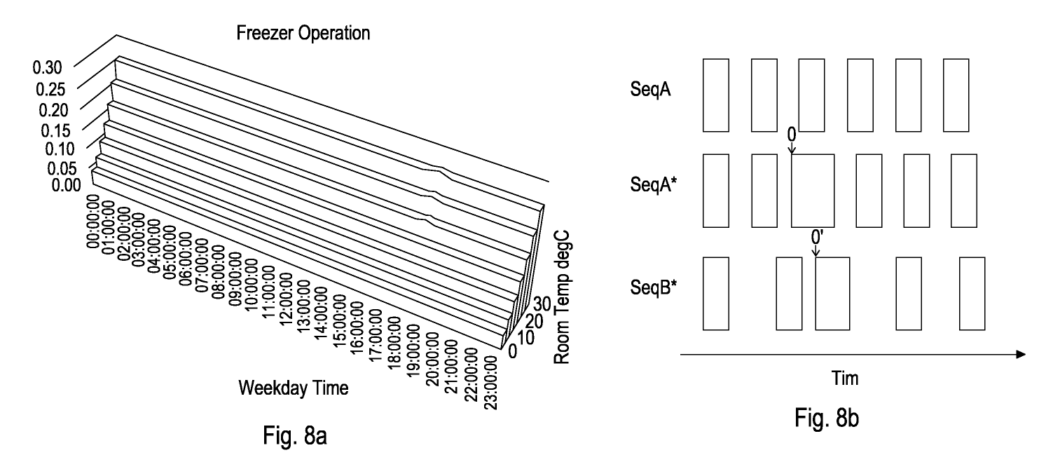

FIG. 8a is a graphical representation of daily operation of a freezer by room temperature;

FIG. 8b illustrates three different modes of operation of a freezer;

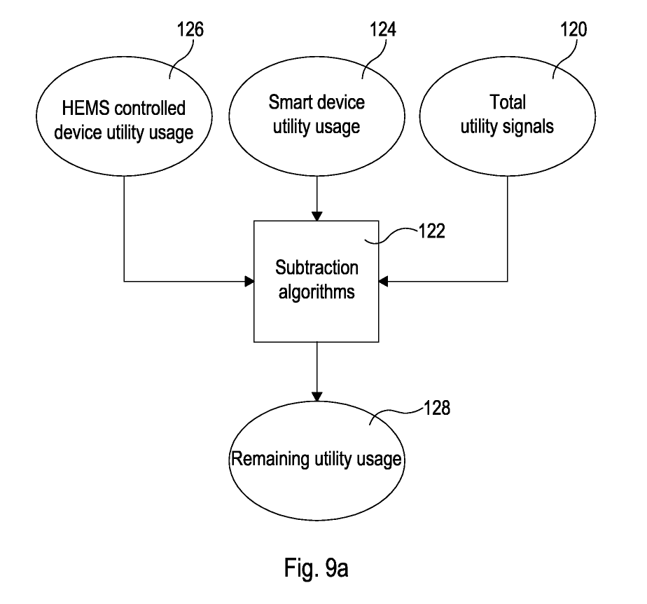

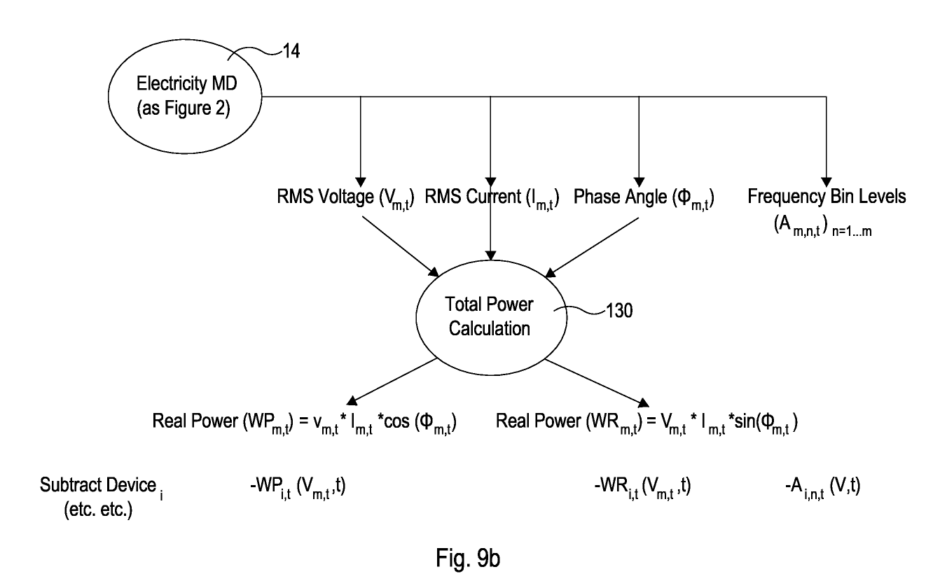

FIG. 9a shows a flow diagram illustrating the subtraction of known appliance usage signals in HEMS;

FIG. 9b illustrates the subtraction of known appliance usage signals from measured electricity signals;

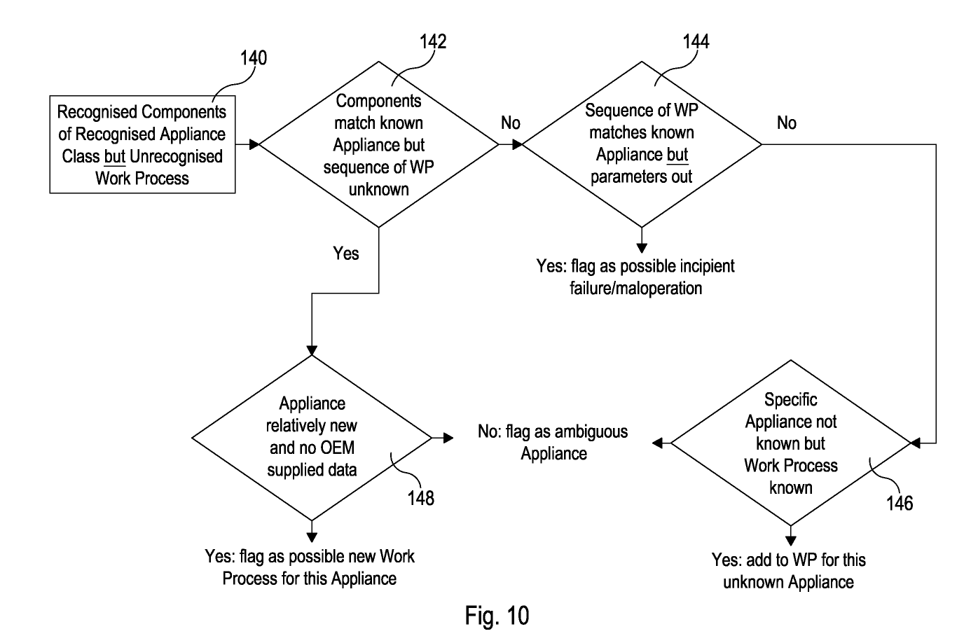

FIG. 10 shows a flow diagram illustrating unrecognised work process disambiguation;

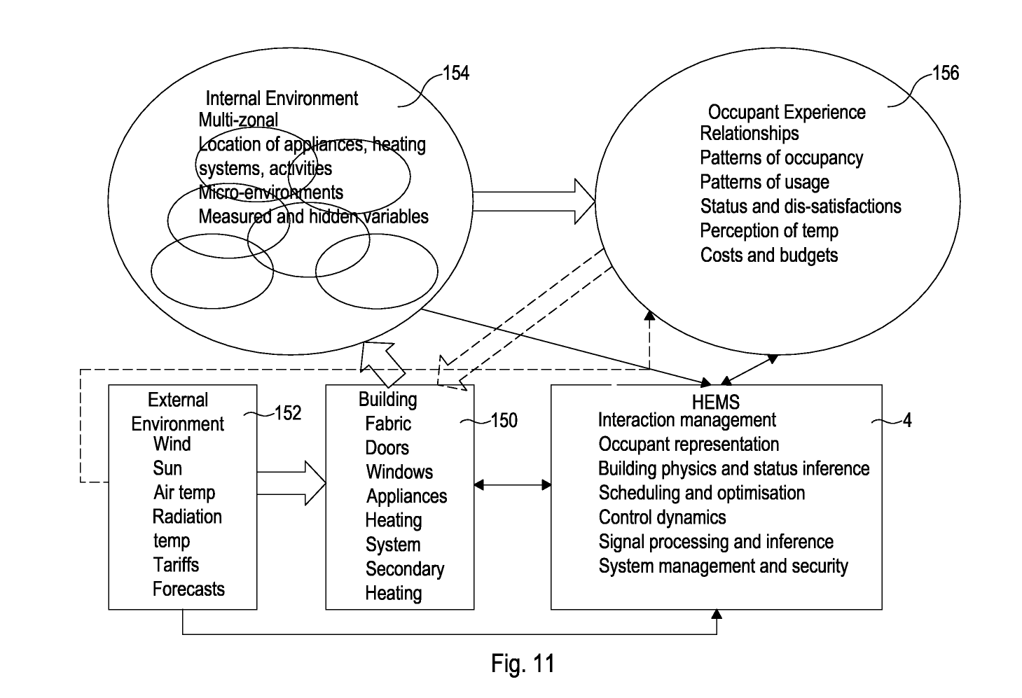

FIG. 11 illustrates the system context for a HEMS in accordance with an embodiment of the present invention;

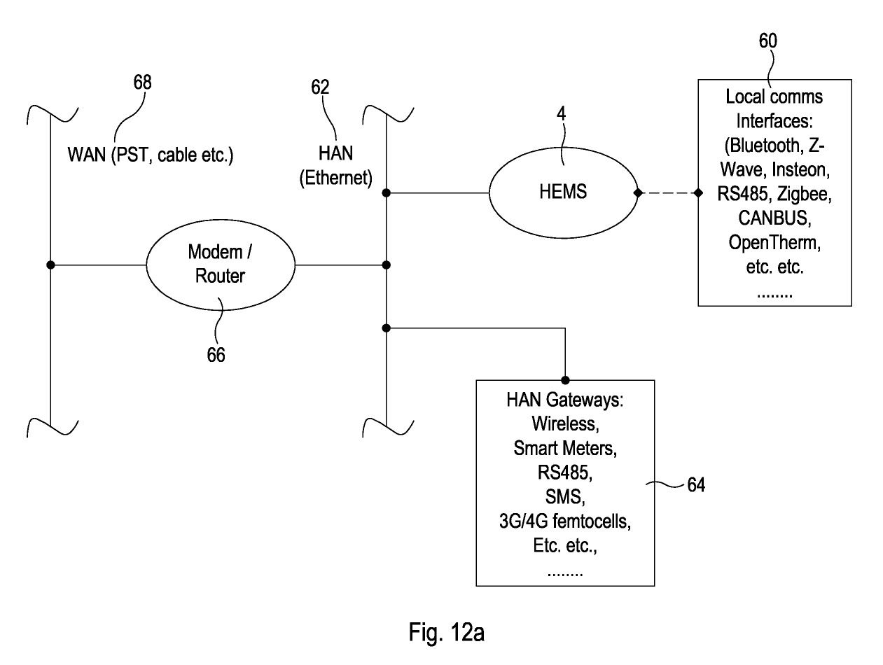

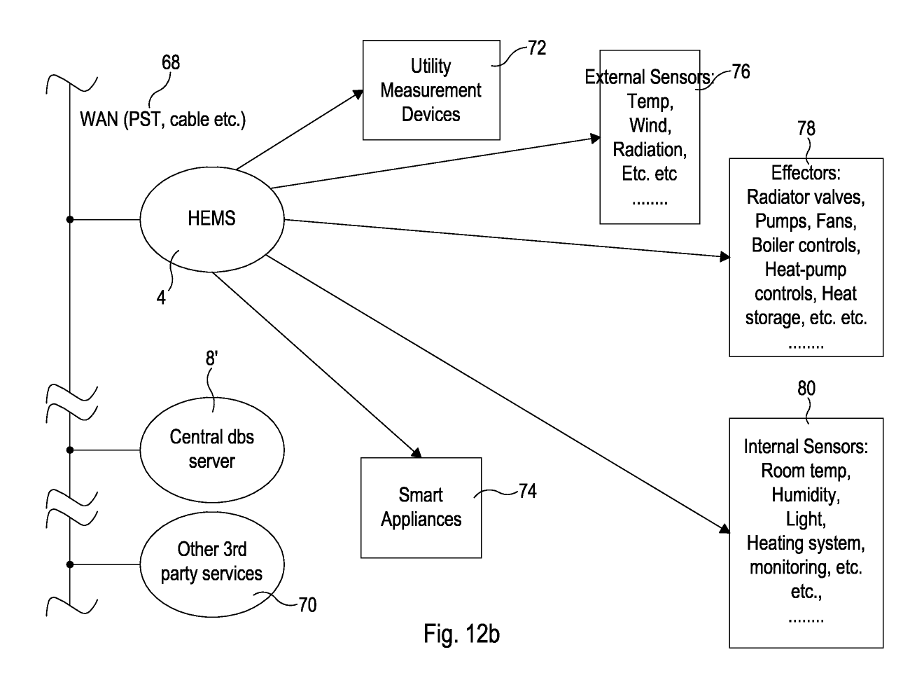

FIG. 12a shows a physical layer system diagram for a HEMS in accordance with an embodiment of the present invention;

FIG. 12b shows a functional layer system diagram for a HEMS in accordance with an embodiment of the present invention; and

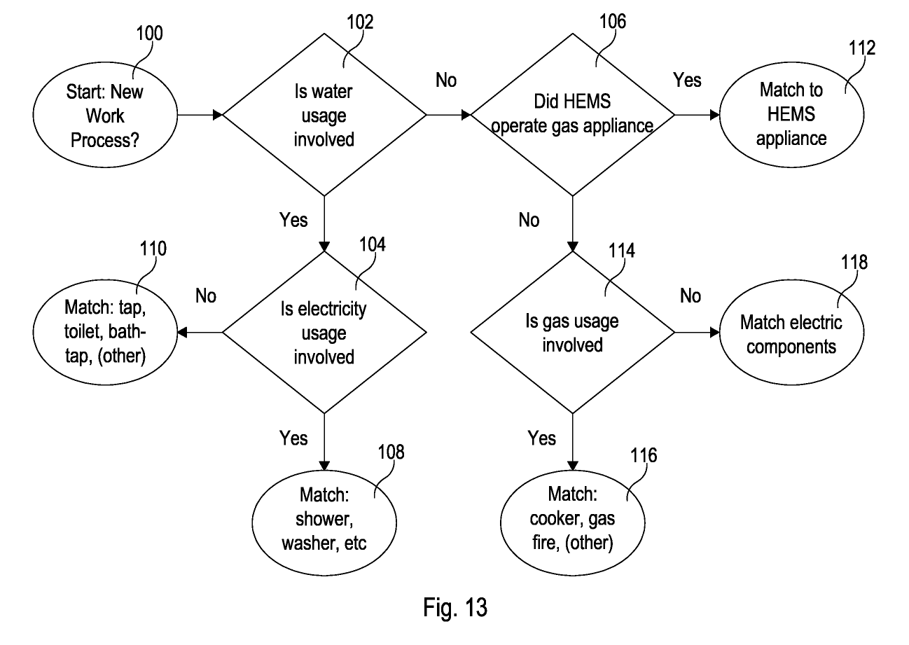

FIG. 13 shows a primary disambiguation example in accordance with an embodiment of the invention.

### DETAILED DESCRIPTION OF EMBODIMENTS OF THE INVENTION

Aspects and embodiments of the invention thus provide for recognition of patterns of appliance usage within a building. This is achieved by combining utility signals such as those relating to electricity, gas and water usage, together with any other relevant energy related flows, and possibly information from other sensors (such as smart devices and those that are part of heating/security systems, for example). The utility usage pattern of each appliance or device can be recognised by (a) primary processing of the signals (e.g. the typical high frequency noise and shape of the signal output of the combination of the components of devices), (b) work process (the pattern of inputs to a device over time, for example the wash and dry cycle on a dishwasher) and (c) workflow (the human use of devices in combination—washing clothes in a washing machine then tumble drying them, or turning lights on, then the TV, then an electric shower). Aspects and embodiments of the invention utilise the disambiguation of energy use patterns subjected to hypothesis testing over many repeat samples to provide a statistical hypothesis relating to on-going instances.

The system architecture of the HEMS is not described in detail as such is known in the art. At a high level, this can be described as an appropriate combination of (a) processes running on hardware located in the specific building (including sensors and effectors), (b) an internet connection, (c) an application running on a personal device (such as a mobile phone or tablet), (d) additional data and processing capability in a shared central server (for example in the cloud) and (e) a web based client for use on any internet connected device.

The HEMS is foreseen as part of an integrated system. Although in principle it would be possible to implement a cut-down version that acts as a stand-alone system, this would not be able to provide all of the value of the full concept and the local HEMS hardware would need to be significantly more powerful (and costly).

In a particular embodiment, the cloud service would be a private service provided by a particular HEMS service provider. The design of IT hardware and system architecture to provide this is a matter of system design optimisation. The selected architecture may vary from provider to provider for a variety of reasons and the dominant design will certainly change with time as IT continues to develop. None of this detail is important to the present invention, except insofar as the optimisation succeeds in delivering the required services effectively and at an acceptable cost.

We therefore consider an abstraction where all the services are provided from a notional or virtual central server (with backup). System resilience, capacity optimisation, scalability and so on would be addressed in the detail of the architecture.

This central server would be operated or controlled by the HEMS service provider and would also link to wider business services such as payment systems (for billing the customer), weather data and forecasts, energy market operation etc. These wider services would be integrated into the service provided to the HEMS user by the HEMS service provider. Some of these services have an obvious and direct impact on what the user sees, such as weather data or entering billing information; some of them are not normally directly visible to the user, such as wholesale energy market transactions.

The central server could be used to provide a range of classes of service across the population of HEMS that it supports:
1) IT system services: such as high power processing, data backup and storage, fault detection, software updating and recovery; these services are integral to each HEMS and would need to be provided locally in the absence of the central server;
2) Business services: such as energy purchase and supply, information purchase and integration, maintenance support and insurance;
3) Statistical and analytical services, such as those required to implement embodiments of the present invention.

The primary customers for the statistical and analytical services are individual HEMS users, however there are other possible users:
Government will want to access aggregated statistical data for social purposes, in a similar manner to other Office of National Statistics data series.
Suppliers and co-suppliers of the HEMS service provider will want to access aggregated data for product design and marketing purposes. For example, a dishwasher manufacturer would value knowing exactly how customers use their products, how a newly launched product actually performs in service and how the performance and components of older products deteriorate with time.
The HEMS service provider will need to use aggregated data to understand their products in a similar way.
Government may also want to provide social services through the HEMS, but this is an individual service provision and not an aggregated one at the point of delivery. For example, it could set an obligation on energy service providers to provide a minimum level of comfort and cleanliness and also monitor wellbeing. This would then be part of the business of the service provider, falling under service class 2 above.

Whether data on individual users is completely accessible to the service provider would need to be determined. For example, a selling point for some mobile phone operators is that their devices provide strong encryption, so that the operator cannot access e-mails and contact details etc. How much protection can be provided to users of the HEMS without compromising service provision is unclear and would be a matter for detailed design.

In principle, individual user data may only be unencrypted where that is necessary to provide a user service. For example, the data backup for each user may not be associated with the user account but with a code known only to the HEMS associated with that particular user. Therefore the HEMS can access and unencrypt the data but no-one else can. The system backup for the HEMS contains the code but encrypted, so that only a hardware key in the HEMS can access the backup. Individual user data may be stored unencrypted but only where it cannot be associated with the user.

These are not technically trivial issues. It is well known that it is possible to provide privacy for users by anonymising individual pieces of data but then possible to put together anonymised sets of data with identified data in a way that unlocks the anonymised data. For example, if there are ten million detailed sets of data from HEMS, but with no links to individual users, it may be possible to identify many individual users armed with their billing address, monthly energy usages and detailed local weather histories.

The implementation of consumer protection measures is not addressed further in this application but there is an assumption that the naïve model of all the data being available to a “central engineer”, who has delegated the analytical task to a computer programme, is not the one that is intended.

The most difficult area in relation to consumer protection is likely to be geographic proximity. Some of the HEMS analyses use geographical information in estimating a priori probabilities, for example that people living closely together are more likely to have similar patterns of behaviour or that new appliances will initially appear in clusters due to stocking patterns in shops and word of mouth recommendations. (The counterfactuals of national launch and recommendations via social media would also need to be considered against real launch data).

Advantageously, the utility data collected can be used to:
1) identify usage patterns of major peak utility using appliances such as washing machines, baths, showers, dryers, heaters etc.;
2) identify major utility users which operate for long periods of time, such as refrigerators, floodlights, sprinkler systems etc., where energy consumption is significant, even if peak energy usage is not so large;
3) identify autonomous systems not controlled by the HEMS, such as automatic ventilation, watering systems, dusk lighting systems etc.; and
4) provide input to the HEMS which enables occupancy and activity patterns to be detected.

These purposes are not clearly identified in the prior art, which over-emphasizes electricity as a single utility and confuses the identification of major energy usage with the identification of human and autonomous activity patterns. Also, it is not known in the prior art to integrate appliance recognition with the control functions of a HEMS. Thus, embodiments of the present invention recognise that some of the inputs required by the HEMS are automatically known to it or it can obtain these directly. For example, the HEMS may know the status of a (gas) boiler or an air-conditioning system, or if a movement sensor of a security system is triggered. Given the degree of control that a HEMS is required to deliver over some of these systems, this information could be quite complex. For example, data from a heating system could include water temperatures and room temperatures in different parts of the system, boiler firing data and water storage tank temperatures. Remote controlled gas fires may be able to share data on temperature set point and smart televisions monitor environmental light levels and can control display brightness in response etc.

Aspects and embodiments of the invention are thus useful in managing and monitoring the home/building environment including where utilities of different types are being used, and what occupants of the home/building are doing when those utilities are being used.

If all possible activities were to be searched every time a utility were used, the size of the computation would be prohibitively large to implement a practical system. Embodiments of the present invention overcome this limitation through use of a priori Bayesian Statistics such that the most likely activities are compared first to reduce the size of the computation and speed up the analysis.

FIG. 1 is a simplified view showing how an appliance recognition module/unit 2 according to embodiments and aspects of the present invention interacts with a HEMS 4. Of course, other units 6 e.g. providing further inputs to the HEMS 4 (such as a budget management or scheduling module) may also communicate with the HEMS 4, but these will not be discussed in detail herein. A plurality of measurement devices 10, 12, 14, 16 is provided, such measurement devices 10, 12, 14, 16 being any suitable measurement device currently available or which may become available in the future. The measurement devices 10, 12, 14, 16 are in electronic communication with the HEMS 4, as will be discussed in more detail below. One or more appliances 7 are also in electronic communication with the HEMS 4. A storage device 8, such as a memory device, is also in communication with the HEMS 4 for storing data as will also be discussed in greater detail below. The appliance recognition unit 2, the HEMS 4, any other units 6, the storage 8, and the appliances 7 are typically located in a building such as a residential dwelling or other property. The measurement devices 10, 12, 14, 16 may also be located in the building, or may be externally located, depending on how and where the utilities enter the building. A central database 8′ is also provided remotely from the building, on a server that services a plurality of HEMS in different buildings.

It should be understood that the diagram in FIG. 1 is mainly conceptual. In practice, the appliance recognition unit 2 may be integrated with and indistinguishable from the HEMS 4 itself (sometimes referred to in this document simply as the ‘system’). Similarly, the storage device 8 may be integrated with and indistinguishable from either or both of the appliance recognition unit 2 or HEMS 4. Furthermore, the actual location of data is not critical to the present invention and may be stored in the storage device 8 and/or the central database 8′.

FIG. 2 depicts in simple form how a utility measurement is made. It may be desirable to select measurement devices 10, 12, 14, 16 which are cost-effective and/or appropriate to the environment/surroundings e.g. which can be integrated with existing fiscal meters etc. In the embodiment of FIG. 2, a water measurement device 10, a gas measurement device 12 and an electricity measurement device 14 are provided. Optionally, one or more other measurement devices 16 may also be provided e.g. to measure steam, hot/chilled water etc. It will, however, be appreciated that one or more measurement devices can be chosen depending on what utilities are being provided to a building, and FIG. 2 is merely exemplary of a typical installation. The provision of each utility to a building is represented by the arrows in FIG. 2. Water is provided to the building via an inlet 20 from a source 18 outside of the building, gas is provided to the building via an inlet 24 from a source 22 outside of the building, electricity is provided to the building via an inlet 26 from a source 16 outside of the building and any other utilities are provided to the building via an inlet 28 from a source 30 outside of the building. The respective measurement devices 10, 12, 14, 16 are located along the supply lines, within the building or externally as is appropriate and/or convenient. An electrical signal 34, 36, 38, 40 representative of at least one “property” of each utility (water, gas, electricity and other, respectively) is produced by each measurement device 10, 12, 14, 16 and provided to the HEMS 4.

The measurements for each utility may comprise one or more of:

1) Amount of value per unit of flow (electricity is voltage, water is constant density, gas would be calorific value but it is too expensive to measure it at each house and the data can be supplied from a central point).

2) Flow rate (electricity is current, water is cubic metres per second, gas is nominal cubic metres per second) (for water and gas the meter provides a “pulse” when the next amount has flowed through).

3) Noise (i.e. the information contained in very fast changes in flow rate). One can hear this for water in a house as thuds, hisses and whooshes. Wth a sound card, one can do the same for electricity. Gas is compressible, so there is no useful data in this category. It should be noted that the supply may already contain some noise from outside (e.g. travelling down the pipes and wires).

Electricity is unusual in that voltage varies with time (50 Hz nominal mains frequency). There is therefore extra information about the load in the “phase angle”, the amount by which the current leads or lags the voltage. FIG. 9b shows how the phase angle phi is used to calculate the real and reactive power. These powers are separately additive and allow for device identification.

In order to have manageable mathematics, the noise is taken as “sound” level in frequency ranges or bins.

It is worth noting that the number of bits and chipsets employed will be determined based on a cost benefit analysis, both in terms of signal processing capacity in the measurement device and also later in relation to the size of the mathematical problem in determining what is happening. If standard sixteen bit chipsets are used they can be obtained at reasonable cost. The cost for longer word lengths would be significantly greater but such word lengths could generate more information. In which case, it would take much longer for the HEMS to solve the equations required and so there is a trade-off between cost and complexity. In some embodiments, less than the full resolving power of sixteen bits may be employed. In other embodiments, 24 bit chipsets may be employed.

Regarding the length of time over which the signal may be averaged for each utility, it worth noting that, in general, we are trying to discriminate events which happen fairly quickly (like switching on a light, going to the sink and turning on a tap). Data compression will allow the storage of data where not much is happening, and so the aim would be for the signals to be measured over a small enough time frame to have real data (i.e. to notice some changes). It is expected that events like switching on an appliance or opening a valve (e.g. tap) will generate enough information to be of value in approximately a one second timescale. Gas is compressible, so the signals relating to gas are smoothed out and it will probably not be worthwhile sampling the gas signal more often than once in every ten seconds. If the sampling is less often than every ten seconds it may not be possible to determine how long it takes a user to turn on a gas ring after entering the kitchen. Again, ten seconds may be shorter than is possible or than is required but the amount of data gathered at such a sampling rate will not be excessive.

It should be understood that all of the measurements will be quantized by both the mathematics of IT (i.e. processing hardware) and also physics. For example, it is possible to calculate pi to an arbitrary number of decimal places but a sixteen bit word will only give decimal numbers to a limited precision. Even with longer words, the underlying signal to noise properties of the sensor and analogue to digital converter, and the drift or reproducibility of the device, will limit the accuracy with which it is useful to report measurements. The question is how small a change can be measured. Conceptually, we can represent the system as a finite state Markov Chain, i.e. it can only have a finite number of sets of measurement values at one time point (albeit very large) and the system moves from one state to the next at the measurement time steps (defined transitions in our Markov Chain). This will allow recognition of patterns of appliance use as a set of additive states over a period of time (e.g. light on, then dishwasher starts). In order to prevent an excessive size of the system (in terms of data), the number of states should be limited accordingly.

In relation to temperature measurements, a low-cost digital sensor (e.g. DS18B20) can report temperature to a moderate precision in up to twelve bits. This allows the sensor to report temperature in steps of 0.0625 degrees C. (precision). The operating range is −55 to +125 degrees C. The accuracy is 0.5 deg C., in the range −10 to +85 degrees C., and the reproducibility is estimated to be around the same value as the precision. Accordingly, if the sensor reports 21.1 degrees C. today that is similar to 21.1 degrees C. yesterday, but the two sensors are also considered to be reading the same if one reports 21.1 deg C. and the other reports 21.6 deg C. (although they could be further calibrated). For building physics purposes, a temperature precision of around 0.1 deg C., reproducibility of around 0.2-0.5 deg C. and accuracy of around 1 deg C. would be desirable so a sensor of the type described above would be suitable.

Different utilities will be characterised by different utility “properties”, which can be measured to provide information on the utility as it enters or is provided to the building. The signals 34, 36, 38, 40 may comprise a plurality of “signal channels” or “measurement channels”, each relating to individual or predefined combinations of utility properties. That is to say, the properties that characterise the amount of water being consumed will differ from those relating to gas, electricity or other utilities.

For example, the properties describing water will include volumetric flow data, and colour spectrum in the frequency range substantially from 60 Hz to 44 kHz. (Colour in this context is used as shorthand to describe the set of noise data about signal levels in the range of frequencies 60 Hz to 44 kHz, i.e. the frequency profile.) This range represents a frequency from just above the mains frequency to the typical limit of a sixteen bit chipset as would be found in the measurement device 10. Monitoring signals at frequencies above 44 kHz is not excluded, but this would add to the cost. Water flow colour can advantageously be derived from a “microphone” type of sensor rather than by analysis of the primary flow signal, to reduce the sensor cost. The data collected will typically be averaged over approximately one second, i.e. flow events can be located in time to one second accuracy. It will, however, be appreciated that a different accuracy could be used if required, e.g. approximately 0.5 s, 1.5 s, 2.0 s.

Gas requires only energy flow data at an approximately ten second resolution, so that utility events can be aligned across all utilities at this time resolution. Again, a different resolution may be employed, e.g. 5 s, 6 s, 7 s, 8, 8.5 s, 9 s, 9.5 s, 10.5 s, 11 s, 11.5 s, 12 s, 13 s, 14 s, 15 s etc.

Electricity has the most complex signal output, including RMS voltage, real power, reactive power and colour at one second resolution. It will, again, be appreciated that a different accuracy could be used if required, e.g. approximately 0.5 s, 1.5 s, 2.0 s.

For each utility being measured, the measurement devices 10, 12, 14, 16 produce one or more digitised signals representative of a property of the utility. It is preferable for incoming electricity and water flows to have a high time resolution (e.g. 1 s) to capture the information as transient changes occur. Gas (or oil) flows, however, are only required at a lower resolution (e.g. 10 s) as this is sufficient to detect usage events.

Other utilities can also be measured where they impact on energy use within the building. The most likely additional or alternative utilities are steam, hot water and chilled water. Given the significant thermal mass of most systems handling these utilities, colour is unlikely to provide a valuable set of signals, and a resolution of approximately ten seconds is likely to be sufficient. Inlet temperature, outlet temperature and energy flow are the most likely valuable parameters to measure for hot and chilled water. Inlet steam flow, temperature and pressure and condensate temperature are the most likely valuable parameters for steam supply.

In accordance with their standard modes of operation, the “primary” measurement devices 10, 12, 14 will produce the corresponding measurement signals 34, 36, 38 as an instantaneous value, averaged over the sample duration, for example approximately one second for electricity or water, and less for the other “secondary” utilities. (Although the “secondary” utilities (measured by measurement device(s) 16 to produce signal(s) 40 are not further specifically discussed herein, data derived therefrom can be collected and processed in a manner that is analogous to the processing of gas, water and electricity data as is described.) The measurements are provided as signal levels in frequency bins, the width of which can be chosen to provide a mathematically logical signal to noise ratio.

On receipt of the signals 34, 36, 38 the HEMS 4 will:
1) time stamp data blocks corresponding to the frequency bin in which each measurement lies;
2) push all the raw data into its working memory (either in one or both of the storage unit 8 or the central database 8′), of e.g. one day's data; and
3) perform lossless compression on the data and store it (either in one or both of the storage unit 8 or the central database 8′).

An important feature of the first aspect of the invention is monitoring for changes in the “state” of each of the output signals 34, 36, 38 at predefined time intervals. That is to say, a finite state analysis is performed on each of the signals 34, 36, 38. In an embodiment, the utility data is conceptualised as a Markov Chain of sequential states of the system. That is to say, the system (i.e. the HEMS 4 including the appliance recognition module 2) monitors each individual measurement channel over time to determine whether it remains in the same state as in the previous time period or whether it changes. The time periods are dictated by the resolution chosen or predefined for each utility as discussed above. The system detects these changes by treating the detected signals 34, 36, 28 as a set of quantized states within the measurement range and time resolution of the individual measurement channel. This is exemplified in FIG. 3.

Herein, at time step n (i.e. at tₙ depicted along the horizontal axis) the signal channel 34, 36, 38 is in the range of the vertical axis shown by the shaded box. This lies within the overall signal range of Rₘᵢₙ to Rₘₐₓ, which is divided into a series of measurement states. The size of each of these boxes (i.e. data blocks) is the larger of:
1) the range implied by the resolution, accuracy or tolerance of the signal digitisation;
2) the reproducibility of the measurement system as established by design and calibration results; and
3) that which is sufficient to give a predefined signal to noise ratio (as explained below).

The measurement devices 10, 12, 14, 16 are unlikely to have perfectly linear responses over their measurement full range and, as such, the boxes for any one channel are likely to be of different sizes. For simplicity, however, the example of FIG. 3 shows equal sized boxes.

The first two criteria listed above are programmed into the system at an initial stage e.g. on installation within the building and the third is estimated after an initial learning period and subsequently re-calibrated with time, based on on-going system learning. There are a variety of methods for establishing the background noise on a measurement channel. One approach is to partition the state transitions on each channel over a training period e.g. of two to three days and to take the 50% of transitions which are smallest (including null transitions), according to a predefined threshold, as representing noise and the other 50% as representing signal (including null transitions). All utility measurement devices are likely to produce more than one signal channel (apart from gas, where noise is unlikely to be an issue), so the signal and noise of channels is compared so that any presumed signal on one channel is accompanied by a presumed signal on at least one other channel. Where this is not the case, then the smallest 90% of initially presumed non null transitions are reclassified as noise. The boundaries of the boxes are recursively adjusted across the channels of each measurement device 10, 12, 14, 16 until the above rules are satisfied. Where the finite states of any channel are significantly less (e.g. fewer than 85% of the number expected from the inherent characteristics of the measurement device), then a report is generated in a HEMS 4 log. The potential causes of a noisy channel are (a) failure of the measurement device 10, 12, 14, 16, (b) a noisy component of an appliance 7 in constant operation and (c) noise injection from the utility supply. Each of these situations represent challenges for embodiments of the present invention, and also potential failures requiring maintenance attention, starting with a diagnostic step which could be automated based on signature analysis gathered from many installed HEMS 4 over a period of time but initially requiring human diagnosis. The system carries out this noise analysis periodically, nominally e.g. once a week.

At time step n+1, i.e. at tₙ₊₁ in FIG. 3, there has been a change in state and the channel signal has altered by four steps. A hypothesis implied by this is that the signal 34, 38, or 28 has altered from being in the centre of the first box (with a reproducibility range shown by the height of the box) to being in the centre of the second box.

The time steps of the horizontal axis are preferably predefined, equal time steps e.g. 1 s, 10 s, as discussed above. The signal range depicted by Rₘᵢₙ to Rₘₐₓ in FIG. 3 represents a signal channel e.g. electrical power.

Recent data collected in this way, e.g. the last 24 hours of Markov Chain data, may be retained in the working memory (e.g. storage unit 8) and older data may be sent to a data store (e.g. central storage unit 8′). Alternatively, the HEMS 4 may retain historic data in working memory and send incremental data to the data store 8′.

Some, if not all, appliances use water and electricity in defined patterns or utility/energy usage signatures. For example, a dishwasher may have a number of settings that a user can choose but, for each, the cycles that it goes through (washing, rinsing etc.) at predetermined temperatures for predefined times is the same every time that setting is chosen. The energy usage patterns are likely to vary between appliance models, and between manufacturers etc., but it is possible to know the expected utility (water, gas) signature pattern for a particular appliance/model. Building on this, at a basic level, not all appliances use water, and so looking for an indication of water usage and/or electricity usage, and also if there is any gas usage, and whether these usages fit the known patterns for various appliances, can enable recognition/identification of an appliance. Another key pattern is that associated with lights. The energy signature for a light is recognisable, and identification of a light being used will identify the room of the building in which an appliance is being used. This information can be used to assist in disambiguating between possible alternative explanations (i.e. a measured combination of water, electricity and or gas usage signals can be compared against known signatures of utility usage combinations characteristic of various appliances in order to test or hypothesise what appliance is likely to be producing the measured signals).

Knowledge obtained from monitoring energy/appliance usage within a building can also be used to make inferences about how occupants of the building use various appliances 7, and the HEMS 4/appliance recognition module 2 can define and test hypotheses to understand what the measured data means.

For example, if, early every morning, it is known that a light is turned on and in that room water and electricity are used, then the light is turned off and then electricity is used in another room, it can be hypothesised that a person has gone into a bathroom and had a shower and then gone into their bedroom to dry their hair with a hairdryer. The combination of different energy signatures, in different locations and at different times, provides an indication of what appliance(s) is(are) being used and a person's activities in using those appliances. This enables identification of appliances, and use of appliances within the building. If a previously unknown electrical energy signal were detected shortly after the above process were carried out each morning, it could be further hypothesised that the person had purchased some hair straighteners and was straightening their hair. Information from other sources could also be used in developing the hypotheses e.g. a sensor that detects a relative rise followed by a drop in humidity would further support the hypothesis of appliance usage in a bathroom.

The appliance recognition module 2 receives inputs from the HEMS 4 on:
1) the hypothesis about who is in the building and the rooms in which they were last detected;
2) access to personal details of the occupants and their historic workflow patterns (as described in detail later);
3) access to building layout information and analysed building measurement data from a system setup process; and
4) information about HEMS connected appliances 7 and their control status.

This is exemplified in FIG. 4, which summaries how a hypothesis is created on the utility usages within a building. The workflows (utility processes carried out by the appliances 7 themselves and sequences of human behaviour, i.e. how and when appliances are used), and the frequency of these activities, are characteristic of a building or household or of individuals within a household. The appliance recognition module 2 is, essentially, monitoring current utility usage activities to analyse against the specific patterns of appliances or devices 7 previously identified in the building.

There is also a historic review process, especially in relation to unidentified patterns. This generates alternative hypotheses about the causation of utility usage patterns and tests their probability of matching a reference appliance/device using information relating to utility usage repeat patterns until the combination of tests provides statistically significant disambiguation. Other information, such as geographical information, or further information from other sensors employed within the building may also be utilised to help identify appliances 7. Thus, the “a priori probabilities”, e.g. the a priori Bayesian probabilities, associated with patterns of appliance usage hypothetically arising from work flow(s), work process(es), appliance(s) and/or component(s) of appliance(s) can be modified by reference to a central history database of these items from other buildings in the same geographic region as the specific building being monitored. The a priori probabilities can be determined by studying the spatial relationships within the central database held in the remote storage device 8′ on the hypothesis that buildings closer to the building in question are more likely to represent it than those further away. Sufficient data is selected to provide a strong hypothesis based on correlations with distance (e.g. assuming inhomogeneity in a pseudo two-dimensional plane). In an embodiment, user input, by e.g. an installation engineer for the system or a user of the system, can be combined with the central data in determining the a priori probabilities. In another embodiment, other information gathered through the installation, setup and operation of the HEMS 4 contributes to the a priori probability inputs.

Furthermore, information created by appliance monitoring can be used as an input to other modules/units 6 of the HEMS 4 including, but not limited to: identification of secondary heating and cooling appliances and their usage for the purposes of environmental control, calculation of utility usage within the building and its allocation to appliances 7, work processes and work flows for the purposes of budgeting and resource optimisation, identification of patterns of occupation for the purposes of control optimisation, identification of patterns of behaviour for the purposes of identifying hidden Markov changes in the status and wellbeing of occupants, etc. Gathering data on the usage and performance of appliances 7 in buildings can also provide valuable generic information to appliance manufacturers, standards setters and regulators on their reliability, patterns of use, achieved efficiency etc.

Aspects and embodiments of the invention thus rely on a combination of upfront (stored) input data representative of typical device patterns, disambiguation within an individual building against workflows, and disambiguation across many buildings of work processes. With a sufficiently large population of installed HEMS, the central server (or a supervisory module linked thereto) may be able to identify the entry of new devices into the market and enable central decisions about the value of additional investigations (e.g. using the data gathered from each HEMS the system may look for external evidence of new devices, for example, using the internet). The signatures of large utility-using devices/appliances are highly likely to be distinctive. For example, gas fires and fan heaters emit unexplained heat, tumble dryers and showers use a large amount of electricity but only one uses water etc. In addition to being able to recognise that new devices, work processes and workflows are in use in the building, the pattern recognition has the potential to recognise developing faults and deterioration of performance. The central server could therefore share this information with manufacturers.

Appliance use is described by a hierarchy as exemplified in FIG. 5. Each appliance 7 in the building is made up of a number of components relevant to the present invention. For example a refrigerator has, inter alia, a door switch, which operates an internal light, and a thermostat which operates the compressor. The HEMS 4 is supplied with a database of appliances, which are also made up of a series of components which can undergo a series of “work processes”. In the case of the exemplary refrigerator, there are two work processes: opening the door and chilling the contents. The “component operation” in this embodiment is thus operation of the door switch, internal light, thermostat or compressor. The entire process, initiated by a person, e.g. opening the refrigerator door, is indicated as a “work flow”. Aspects and embodiments of the present invention thus utilise detecting and recognising “hidden states” both in terms of appliance usage and human activity.

Each individual HEMS in a set of many HEMS operated by a HEMS service provider (via a central server) is working with data on appliances in a particular building, as described above in relation to FIG. 5. These appliances may be recognised and grouped as follows:
1) A smart appliance which declares itself through its network connection or an appliance that is recognised from an appliance description supplied by the OEM to the HEMS provider and used by an individual HEMS.
2) An appliance which is recognised by the central server as a result of homologating data from individual HEMS.
3) An unknown appliance which cannot be homologated to an appliance in the central server database but which fits an appliance class (e.g. washing machine).
4) An unknown appliance which cannot be unambiguously assigned to an appliance class. This category also includes unknown components (of appliances) which cannot be assigned to an appliance class.

Known components which cannot be assigned to an appliance by an individual HEMS or by the central server may be logged in central database but the added value of doing this and risks of this are unclear and the main focus is on appliances that the HEMS has identified. The only component class for which this is likely to be important are the individual elements of lumieres—“lightbulbs”.

Each HEMS will also have utility usage which it is not able to assign unambiguously to appliance or component classes—for example a mains powered smoke detector and a wireless router will be hard to detect from the very limited data the system can collect about them. Given the main purposes of the HEMS (to capture patterns of human occupancy and to analyse and control utility usage), disambiguating background electricity usage is not that important. If someone is really interested, they can disconnect each appliance in turn to see its power consumption. However, it is expected that less than 5% of users will want to do that and it is easy to create a scheme to enable it.

Individual HEMS and the central server work together to recognise and collect data on appliances. The central database logs and tracks all instances of group (3) above and attempts to convert them to group (2):
By clustering the characteristics of all unknown appliances (across all HEMS) of a known class in multi-dimensional phase space (the dimensions are chosen to represent the differences between instances in the most parsimonious and robust way, using mathematical techniques that will be familiar to one skilled in the art). Using the characteristics of known appliances in the same class, the typical dispersion of instances of appliances of that class on the characteristic parameters can be used to test the hypothesis that a cluster of individual instances represents a unique appliance.
Where the instances are clustered in geographic locations and are all newly installed, then the appliance is flagged as probably newly on the market and reported to a (human) system supervisor.
Where the instances are found already installed in the majority of cases, the appliance is registered as a known but unidentified appliance of the relevant class and flagged to the system supervisor.

Of course some will remain in group (3).

The process by which an individual HEMS uses the central database to identify appliances in groups (1) and (2) is described in detail herein. Essentially the characteristics of the appliance are compared to known appliances for goodness of fit, in a similar manner to the clustering described above. Other clues, such as data collected at setup and responses from the HEMS user can also be used to improve probabilities. In order to do this, the central database will collect frequency data on the error rate of misidentification of appliances in the setup process and from user input (for example caused by mistyping the characters in a product code).

For appliances in groups (1) and (2) the central server will collect data on each appliance, grouped under appliance classes. This data will include data on rates of malfunction and deterioration. This condition monitoring data can support:
Provision of services to appliance manufacturers.
Provision of maintenance services to HEMS users, including services to do with end-of-life replacement.
Recognition of already installed appliances in new HEMS where the appliance is not functioning correctly.

The level of clustering will depend on the degree of difference in phase space. Where appliances have identical model numbers but different components (for example different motors), then the instances will only be shown as separate where the differences create two clusters at the appliance level. Similarly where an appliance has more than one model number, but only one cluster, then the different model or build numbers will be shown as the same appliance. Having different plugs or different coloured panels does not change the essential characteristics of the appliance in terms of human behaviour, utility usage and work processes.

The individual HEMS can use the central server data to recognise appliances, either when the HEMS is first installed or when a new appliance is detected. Parameters of each appliance class are structured around the components and work processes known for that class of appliances, with the specifics of each appliance derived by class inheritance and populated with real data on the distribution of values of parameters.

Where a previously identified appliance either drifts or jumps to a statistically unusual value of a parameter, then a potential fault condition is flagged. Over time, feedback from maintenance technicians can be used to identify common fault conditions, so that they can be recognised from parameter values. This will be particularly valuable for incipient faults, where the pattern before failure is recognisable.

Where a new appliance is unrecognised but there is evidence that it should have been, then the system may also be able to make a fault diagnosis. For example a user buys a new washing machine. The HEMS recognises a new washing machine but not the model. The particular user maintains a high level of dialogue with the HEMS and provides the model number. The post hoc probability is now that it is recognisably that model with a known fault condition. The user can be told that it is faulty. This cannot be done without the model number because there is the obvious potential for a minor model upgrade to appear as an out of tolerance example of the older model. Appliance manufacturers may need to be disciplined in allocating build or model numbers or in providing appliance data in order to avoid fault reports from users.

In addition to characteristic parameters that allow the appliance to be recognised, the HEMS and central server also collect appliance usage data. In principle the HEMS also knows about the occupants and can correlate patterns of usage with occupant characteristics. This can add to the a priori probabilities for disambiguation but clearly has some consumer protection risks to using location data. The appliance usage data can be used to:
Provide benchmark data to consumers on their usage compared to others like them.
Provide data to manufacturers on the use of their appliances—for example what is the distribution of frequency of usage of washing machine cleaning cycles and how does it relate to other usage parameters.
Provide data to policy makers on aggregate usage of different appliance classes—for example how much energy is used in washing and drying and how does this relate to appliance design. An example of this would be the extent to which the location of a freezer determines its energy use as opposed to inherent efficiency.

The HEMS also enables the integration of appliance usage data into the design and delivery of service products. We earlier gave the examples where faults found during service are fed back into the central database and incipient failures enable a preventative maintenance visit to be scheduled. A similar facility to that in modern cars will also be possible, where maintenance can be scheduled based on usage and not just time elapsed and all of this data can be fed into the design of the appliances and also service products like insurance and maintenance contracts.

With regard to creating the stored data representative of typical devices/appliances, the appliances, or the components of these appliances, can be described and written in a computer meta-language. Class inheritance can be used to reduce the task of creating data representing the appliances. An appliance consists of a set of work processes that employ component operations which use utilities in a set of time series patterns whose characteristics can be described by instancing classes in the meta language.

For the example of a dishwasher, as illustrated in FIG. 6, a manufacturer wishing to supply a description of their product would create a definition in the meta language that would define, for a particular model and build, which components 50 it employed. The individual wash programme cycles would be the work processes 52 and the elements such as heaters, pumps etc. would be the components 50. It will be understood that user actions 58 will be required to fill the appliance with dirty dishes, turn on the power, select and start a program (e.g. work process 52) and subsequently turn off the power and empty the dishes, although many of these steps are sequence independent. Of course, the actual electric usage 54 and water usage 56 signatures will be dependent on the work process 52 (i.e. program) chosen.

A specific model build could be derived by instancing the generic class of dishwasher published by the HEMS developer into a range of dishwashers with specific utility use characteristics (e.g. electric usage 54 and water usage 56) and then into a specific model with a defined set of programmes and components and finally a specific build with exact definitions of the components used, overwriting some of the default parameters in the components with specific values.

In a preferred version of this approach the manufacturer supplies appliances together with the distribution of parameters of utility using signatures of components and work processes of as manufactured appliances and aging functions over time. Manufacturers could also add value by measuring the signatures of each appliance as manufactured and supplying that with the appliance. For some components, such as light bulbs, there will be added value in deliberately using manufacturing processes to produce defined and well-distributed variations in signatures, so that each light bulb in a building can be distinguished through combinations of slight variations of power, start-up time etc., since the probability of having two bulbs with indistinguishable characteristics is a priori low enough to ignore. Even without this approach, the central database will contain information on component distributions that can be used to improve appliance recognition.

The meta language should be capable of instancing using formulae and conditional clauses, both in terms of compilation and operation. The language may represent both parametric and algorithmic relationships. The rules of the meta language provide a rich set of potential descriptions (so that complex operations can be described) and also extensibility (to allow for future component and process features not currently in existence). The top level of the class description describes the super classes of work flow, work process, component and the binding of work processes and components together that represents an appliance. There are a number of existing computer languages that could be used to implement such a set of descriptions.

Work flows represent a time series of work processes with individual occupant inputs that determine their characteristics: natural language description (where relevant), parameters of each work process and distribution of time between each step in the work flow. The appliance recognition module 2 does not allocate work flows to individual occupants, but other modules 6 of the HEMS 4 may tag instances of work flows as characteristic of an individual occupant or part of an unassigned pool.

In addition to occupant led work flows, there are also autonomous work flows, such as a refrigerator compressor switching on, a sprinkler system operating or night-time security lighting operating. These work flows can be attached to components that are sensors for hidden state variables (e.g. refrigerator internal temperature) or potentially estimable by the HEMS 4 (e.g. outside light levels or time of day).

Describing an appliance 7 at an appropriate level of detail will require considerable skill and experience. For example the exemplary dishwasher is likely to have a switch that interrupts the programme if the door is opened. In an embodiment, the HEMS 4 can detect and discriminate this event from normal operation. If the dishwasher restarts when the door is closed, then the corresponding signature will be described in the meta language. A washing machine or microwave that uses sensors to monitor its load will have a wider variation of work process parameters than one which follows a defined time sequence of component actions and parameter values.

Appliances 7 that can be operated by the HEMS 4, such as boilers and their associated components, can be configured at installation and the HEMS 4 will notify the appliance recognition module 2 of the current state of its control inputs. Also the HEMS 4 may be connected to smart appliances (not shown) which can identify themselves and their state to the HEMS 4. These appliances 7 can be treated in the same way as HEMS 4 controlled appliances 7, apart from the possibility of detecting user input.

FIG. 12a shows a physical layer system diagram for a HEMS 4 in accordance with an embodiment of the present invention. Thus, it is envisaged that the HEMS 4 would have a number of local communication interfaces 60 (e.g. Bluetooth, Z-wave, Insteon, RS485, Zigbee, CANBUS, OpenTherm etc.) and would be operated on a home area network (HAN) 62 which also has a number of HAN gateways 64 (e.g. wireless, Smart Meters, RS485, SMS, 3G/4G femtocells, etc.). A modem/router 66 would then connect the HAN 62 to a wide area network (WAN) 68.

FIG. 12b shows a functional layer system diagram for a HEMS 4 in accordance with an embodiment of the present invention. As mentioned above, the HEMS 4 is connected to a WAN 68 through which it can communicate with a central database server (i.e. storage) 8′ and other 3^{rd} party services 70. On a local level the HEMS 4 is connected to utility measurement devices 72 and may also be connected to smart appliances 74, external sensors 76 (e.g. for temperature, wind, radiation, etc.), effectors 78 (e.g. in the form of radiator valves, pumps, fans, boiler controls, heat-pump controls, heat storage devices etc.) and internal sensors 80 (e.g. for room temperature, humidity, light, heating system monitoring etc.).

Processing utility input data has foreground and background elements. Thus, the appliance recognition module 2 may be considered to comprise a foreground processing module and a background processing module. In an embodiment, in the foreground processing, the HEMS 4 constructs a hypothesis about the short term (typically e.g. 60 to 120 s, typically 100 s) expected forward Markov Chain of each measurement channel, based on the work processes hypothesized to be active at the current step. As the slowest measurement channel updates, the system state is checked against the hypothesised prediction. If this matches, then the appliance recognition module 2 captures and allocates the utility usage data across the work process, appliance and work flow hierarchy (FIG. 5). The forward chain is reforecast and the appliance recognition module 2 continues with data management as described above.

If the system state diverges from the forecast (i.e. outside tolerance), then the HEMS 4 first tests the hypothesis that a work process has been completed. In this case, the system updates as above, but it also transmits the usage data for that work process to the HEMS 4 (allocated to the specific appliance) for further use. Changes to appliances and any smart appliances controlled by the HEMS 4 are automatically incorporated into the forward chain forecast, to avoid unnecessary computation, but the usage data is captured.

Where the expected/hypothesised normal completion of a work process does not explain the actual current state of a utility or utility channel, the system enters a different loop that attempts to identify the cause of the deviation. The system starts to buffer incoming measurement channel data on signals 34, 36, 38, 40 for analysis. The first step is to search across all appliances 7 for potential user inputs that could explain the Markov Chain accumulating in the buffer (i.e. in the local storage unit 8). The second step is to search for autonomous changes that could explain the Markov Chain. From this reduced set of work processes, a search is carried out on the work flows that include these work processes to assign a most probable cause.

Potential causation hypotheses tested are:
1) a new work process has been initiated as part of an active work flow that follows from recent work processes, for example a shower was taken and now a hairdryer is in use or the washing machine cycle completed and the tumble dryer is in use; or
2) a new work process has been initiated as a first work process in one or more known work flows, including single process flows, such as a light being switched on.

All previously known work processes are, by definition, part of a work flow that includes at least that work process.

The appliance recognition module 2 maintains statistics on the previous use of each known component, work process, appliance and work flow. These statistics may, inter alia, include any one or more of:
1) frequency distribution by absolute time of day;
2) seasonal frequency distribution;
3) frequency distribution relative to estimated outside light levels;
4) frequency distribution relative to assumed occupancy by at least one occupant;
5) weighted aging statistics—time of last known use, median time in historic usage and frequency distribution by time of day in previous month; and
6) distribution of time gaps between work processes in a work flow.

As such, the a priori probabilities include exogenous factors such as time of day, time of year, daylight time, external temperature and hypotheses about the occupation state of the building based on other inputs and other factors for which a state estimation is possible and which are obviously potentially correlated with appliance usage patterns, either through autonomous means (such as daylight switches) or human factors (such as sleep or thermal comfort).

There may be more than one hypothesis of appliance usage that could fit observed data. Primary disambiguation of such alternative explanations can occur by examining the utility usage patterns of appliance components. Of note, water is important and useful in the disambiguation process since it is only utilised in some work flows and work processes, and then in specific and often predictable ways. If more than one explanation survives this “filter”, then the statistics referred to above are used to assign probabilities to the alternative explanations.

FIG. 13 shows a primary disambiguation example comprising the following steps:
100. Initialise new work process review
102. Is water usage involved? If yes proceed to step 104, if no proceed to step 106.
104. Is electricity involved? If yes proceed to step 108, if no proceed to step 110.
106. Did the HEMS operate a gas appliance? If yes proceed to step 112, if no proceed to step 114.
108. Search for a match with known/generic appliances in this category (e.g. shower, washing machine, dishwasher etc.)
110. Search for a match with known/generic appliances in this category (e.g. tap, toilet, bath-tap, other)
112. Search for a match with known HEMS appliances (e.g. gas boiler)
114. Is gas usage involved? If yes proceed to step 116, if no proceed to step 118.
116. Search for a match with known/generic appliances in this category (e.g. cooker, gas fire, other)
118. Search for a match with known/generic appliances/components in this category (e.g. electric components).

Reference to “other” appliances implies searching a complete list, for example, including re-pressurising the heating system or bleeding a radiator. Frequency distributions are used in this analysis according to their weighted explanatory power, as exemplified in FIGS. 7a, 7b and 8a.

For example, FIG. 7a shows a frequency distribution example for a bedroom light and FIG. 7b shows a frequency distribution example for a security light. The switching on/off of different lighting can be distinguished at various times of day, depending on the season. Even in the twilight zone, the probability of switching is different during different months. However, these probabilities could be enhanced by a daylight sensor. As the security light is autonomous, the probability of it switching on overnight is 1 (i.e. 100%) at all times of year but the duration of its operation is different depending on the time of year. By contrast, the probability of the bedroom light being switched on in the morning during the winter months is only approximately 50% and the probability of the bedroom light being operated in the evenings is significantly lower (0-15%).

FIG. 8a shows a frequency distribution example for a freezer compressor, which shows that the operation is not time dependent but room temperature dependent, with the greatest probability of operation (of 25%) being when the room temperature is highest. Accordingly, two similar refrigerator/freezer systems can be disambiguated by estimating the temperatures of the rooms they are in (e.g. garage versus utility room). Also any different patterns of door opening will contribute to modest but visible clues, like the evening bump, where the door is opened during preparation of dinner. FIG. 8b illustrates three different modes of operation of a freezer. For an individual unit at constant room temperature, you will see a pattern of operation like SeqA, where the unit heats up until the compressor switches on, cools down and switches off at regular intervals. SeqA* shows a point O where the door is opened and food is added, causing the compressor to switch on earlier than expected and for longer. In this case, the disruption to the normal operation could impact on more than one cycle. SeqB* shows a similar scenario to SeqA* where the door is opened at O′, but for a lower room temperature (i.e. a less frequent operation).

The exact detail of the probability weightings is a matter of experienced fine-tuning but the general principles are that statistics based on larger numbers of samples carry more weight, that distributions with less dispersion (multi-modal variance) carry more weight and that the aging statistics are used to check disambiguation as an alternative hypothesis, according to the example truth table shown below:

| | Component A | Component B | Component C |
|---|---|---|---|
| All data (since day | Yes | No | No |
| zero) | | | |
| Recent data | Ambiguous | Ambiguous | Ambiguous |

In this example, any one of components A, B or C could match the pattern of utility signals i.e. any of components A, B and C could be matched to recent data that has been obtained. Looking at the usage context statistics (“All data”), component A appears to be the most likely responsible component, however the recent usage pattern is less consistent with this and this usage is therefore flagged as ambiguous.

In the case where the component is recognised as a known component, there is a hypothesis of an unknown work process attached to the appliance. The foreground process can collect the data against the appliance, but it makes a record of the data sequence location in time as an instance of an unknown work process. It also creates a new work process against the appliance definition that contains the new utility usage pattern. The work process data capture continues on the assumption that activation of any components associated with this appliance within a period of time of e.g. up to two or three times the duration of known work processes of that appliance is part of this new work process.

In normal operation, the background process is launched when any of the following situations arise:
1) there is ambiguity in component identification;
2) a new work process is identified;
3) the time is reached when a previous operation of the background process requested it be restarted (typically, the background process will request that it be run e.g. monthly, in the absence of other drivers); or
4) a review is requested by another module 6 of the HEMS 4.

The background process has access to the entire history dataset and current status of the HEMS 4 at the point it is launched. This data is frozen, in the sense that it is not updated while the background process is running. This is achieved by taking a full copy of the current data and by using the last time step of that copy as the horizon of any review of historic data.

Whereas the foreground process limits its search to components, work processes, appliances and work flows that are already assumed to be present in the building, the background process has the tasks of dealing with ambiguity, updating and reviewing the component, work process, appliance and work flow data and managing on-going alignment between the appliance recognition module 2 and other HEMS modules 6.

The background module is first run as part of the engineer setup and installation of the HEMS 4. In this “setup mode” the HEMS 4:
1) receives input that identifies the presence of appliances 7 in the building. This may include:
   a. a smart device declaring its presence through a Home Area Network (HAN);
   b. identification of an appliance 7 through an engineer or lead user scanning a Qcode, barcode or other electronic signature provided on or related to an appliance 7;
   c. identification of an appliance 7 from other information on the appliance 7 or its documentation (i.e. a model number);
   d. a listing of appliances 7 observed in the building, such as, for example, two refrigerators, four televisions, a heat-pump, PV panels etc.;
2) where the appliance 7 declares its presence, the HEMS 4 will use its inbuilt data tables (not necessarily located on the in-home unit 4) to discover how to access a specific appliance description (according to FIG. 4). This description could be in the central database 8′ which is shared across HEMS users, available from the appliance 7 itself, or available from a server operated by the appliance original equipment manufacturer (OEM) or another party on their behalf. The background process will attempt to install all accessible appliance descriptions and analyse any differences between them, in order to offer the engineer the option of choosing one as the proposed known appliance. Any materially different descriptions will be retained as back up hypotheses, with probability weightings that depend on the specific characteristics of the differences, with typically not much lower weighting than the lead candidate;
3) a similar process will apply where a Qcode is used, other than the appliance 7 not being a potential source for its description;
4) when the appliance 7 is identified from other information, the HEMS 4 attempts to search its central database 8′ for other appliances that are matches or near matches for the product codes. These are all treated as candidates for the appliance 7. The engineer is invited to weight the choices according to plausibility;
5) where only generic appliance types are provided, the HEMS 4 starts with a long list of all appliances that fit the description, weighted by their known prevalence within the geographic region of the new HEMS installation. Where the appliance 7 is described as a new or recent purchase, the HEMS uses data based on new appliance 7 instances that it has detected in that geographical region;
6) the HEMS also adopts a null hypothesis that this is a new and previously unknown appliance that fits within one of the generic parent appliance classes. For example, a light fitting (lumiere) could have a wide range of bulb types, ratings and numbers. Just knowing how many light fittings there are in each room and whether they are fixed or plugged-in, leaves open an enormous range of possible component descriptions that could fall under each lumiere;
7) the setup process also adds an error rate and type analysis to the collection of initial appliance hypotheses. This is based on statistics from previous installations. This may consider which appliances are possibly present but frequently not reported, or which appliances are typically misidentified in terms of their characteristics etc. Events with an occurrence rate greater than one in twenty, for example, will be included as sufficiently probable to be worth considering;
8) from the combination of processes, the HEMS 4 starts with a set of potential appliances with an a priori probability of their presence in the building. In addition to specific instances of appliances, the HEMS 4 has a null hypothesis for each appliance class that essentially represents all components in the database that are known to be included in all instances of that class of appliance, plus the parent component class of all classes of component that are known to be used in that class of appliance. The a priori probabilities reflect the geographic experience of instances of appliances in the area where the HEMS 4 is installed and the geographic experience of instances of components in the region where the HEMS is installed. The scale of an area or region will be determined by the geographic probability distributions held within the central database in a means that will be obvious to one skilled in the art. A priori in the UK, the “area” is likely to be analogous to TV broadcast coverage and the “region” is likely to be the UK. As the scale of data increases then both are likely to shrink, depending on sales and advertising and behavioural distributional factors;
9) the probability cut-off for inclusion of a specific appliance instance may, in an embodiment, be one in a hundred, on the basis that there are so many models of any one class of appliance that any higher bar would normally exclude all specific instances of many classes of appliances. Other values may be used. In any case it is quite likely that for some classes, such as lighting, there will frequently only be the parent class included on the initial shortlist;
10) the setup process may also involve the engineer inputting information about the building layout, specifically the location of major appliances, and also the occupants of the household, if only how many adults and children there are. Inputs by the users could enrich this by providing clues about who uses which bedrooms and who feels strongly about the temperature settings in which room. To the extent that other HEMS modules 6 are able to provide input about location, the appliance recognition module 2 can use it in constructing workflow hypotheses—e.g. showers occur in bathrooms and shower rooms, hair is often dried in bathrooms and bedrooms;
11) the HEMS 4 should also be able to provide significant appliance and component data about the primary heating system and any connected security devices such as movement sensors, smoke and CO alarms etc.

Following setup, the appliance recognition module 2 will enter a period of learning or training. During this period it is gathering data in foreground mode but not attempting to identify devices/appliances 7. Noise calibration routines are performed to clean up the data, which is being written to the history file. The appliance recognition module 2 is only able to provide gross utility usage data to the HEMS 4, although it will be able to revisit this later, since all the data is stored. This training period should last long enough for sufficient information to be gathered on the work flows for identification of the patterns of appliance usage. To some extent this is a statistical test—if the appliance recognition module 2 is not able to come to sufficiently strong conclusions, then more time is required. For example, a month of continuous occupation of the building would be a reasonable period to gather data before attempting to carry out the first appliance identification as, within this time period, regular and pattern usage of various appliances should have occurred.

There are a number of known algorithmic approaches to recognising appliance activity from utility data. Aspects and embodiments of the present invention are distinguished from them by utilising the finite state analysis, and also the a priori probability analysis, and further by applying the concepts of work flows as a set of work processes and of using a shared database to set initial probability estimates. In addition, aspects and embodiments of the present invention are not attempting to identify what devices are present in a building from a state of pure ignorance. Not only does the method recognise that there is likely to be a refrigerator in most dwellings (unless all of the surrounding ones for some distance do not have them), it also has inputs from the installation engineer on major visible appliances, number of rooms and therefore likely number of lumieres etc.

The optimum solution will be a combination of algorithms which start from the a priori probabilities. Since there will be pragmatic trade-offs in any application of aspects and embodiments of this invention, not least between fidelity and cost, the most suitable approach for any application cannot be exactly determined in advance.

To further aid understanding, the HEMS 4 may be considered to be an experienced engineer analysing the data forensically, using a computer and a selection of mathematical algorithms to search large spaces efficiently using a combination of different approaches.

The very first step is to identify the patterns that the HEMS 4 already knows about from smart appliances and other appliances 7 connected to the HEMS 4. The utility usage patterns have the estimated signature of these appliances removed. This is not a trivial process; in outline it is described in FIG. 9a which shows a flow diagram illustrating the subtraction of known appliance usage signals in a HEMS 4. Essentially, the total utility signals 120 are input into a subtraction processor 122 along with known smart device utility usage 124 and HEMS controlled device utility usage 126 so that the remaining (unidentified) utility usage 128 can be extracted.

FIG. 9b illustrates the subtraction of known appliance usage signals from measured electricity signals. In this case, the electricity measurement device 14 measures RMS voltage, RMS current, phase angle and noise amplitude (in frequency bins). The RMS voltage, RMS current and phase angle are used in a total power calculation 130 to extract the real and reactive power components. The real and reactive power components and noise amplitude in each frequency bin which can explained by known HEMS connected devices are subtracted as shown, to leave the components to be explained by the HEMS analysis. (Note that the values to be subtracted can vary with supply voltage and that reactive powers can be negative, depending on the capacitance and impedance of the device.)

The next stage is to look for explanations of utility usage. As mentioned above, it is convenient to start with instances of water usage, since there are fewer of these than electricity uses. The stages of this are:
1) request water heating work process data from the HEMS 4. The simplest version of this would be a gas combi-boiler firing to heat hot water. The HEMS 4 is queried to provide data on water heating. The form of data will depend on the heating system. In the simple case of a gas combi-boiler, then the data will be exactly correlated with water use, since the combi-boiler heats water instantly, directly from the mains. In the case of a hot water storage tank with both a gas boiler and an immersion heater, then the HEMS 4 needs to supply the relevant control input data, measurements on the tank status and the appliance model for the tank. The appliance recognition module 2 can then isolate the elements of the two work processes (one for the boiler and one for the immersion heater) from the data histories for water, gas and electricity;
2) identify component signals from motors that are present in appliances 7 of the building. Motors generate distinctive patterns of electricity use which can be isolated from the electricity signal channels. The identified motor events should be pruned of any pumps, fans etc. associated with the heating, ventilation and water sub-systems connected to the HEMS 4;
3) these motor events are then tested against the generic class data for appliances 7 containing motors that are likely to be in the building. This should identify major loads, such as washing machines, tumble driers, dishwashers etc., leaving some smaller motors such as fans, refrigerators & freezers, hair dryers etc. less clearly identified.
4) these remaining motor events are then searched for refrigerator and freezer patterns. The assumed model is that these switch on at regular intervals, which depend on the temperature in their location supplied by the HEMS. Where their location is unclear, the search tests the hypothesis that they are either in the kitchen area or the garage. In addition to these routine background events, the sequence is also interrupted by refrigerator and freezer door openings which involve a low power lamp and then a period of increased chilling load which depends on the period of opening in a non-linear fashion but is positively correlated. This also should identify the signature of any lamps in the refrigerator/freezer;
5) the utility data records are then cleaned of the electricity and water work process data for the appliances 7 related to these larger motors;
6) the remaining appliances 7 should then consist of (a) secondary gas and electric heating, (b) lighting, (c) small motor devices, (d) IT and entertainment devices, (e) taps and watering systems and (f) background loads such as security systems not connected to the HEMS 4, emergency torches etc.;
7) the appliance recognition module 2 will then scan the water and electricity reference records looking for autonomous devices which operate in patterns which are driven by time of day, time of week, daylight time, outside temperature etc.;
8) the appliance recognition module 2 will request data from the HEMS 4 on secondary heating inputs, i.e. detected heat inputs to rooms which are correlated with gas or electricity usage, but are not from HEMS 4 linked appliances 7. These may also include small motors (fans) or not. The signatures of these should be clearly identified in the gas and electricity data. The appliance recognition module 2 needs to disambiguate cooking activities in the kitchen from space heating;
9) other kitchen activities should now be distinguished by looking for work flow patterns which include lighting, extraction fans, kettles, toasters, microwaves, ovens and grills, sink usage etc.;
10) the measured electricity data is scanned for appliances which are pseudo constant power and those which are pseudo fixed resistance, using the natural experiment provided by varying supply voltage;
11) using data on the utility usage patterns which appear to be activated by occupants, the timeline is broken into periods when: the building is actively occupied, the occupants are all asleep and the building appears to have no occupants. Although these can never be unambiguously determined, the aim is to develop a strong hypothesis. For example, where a burglar alarm is attached to the HEMS 4, then setting and un-setting the alarm provides a strong hypothesis about specific absence or presence within the building. Not setting the alarm however is not conclusive;
12) the measurement data is then checked for periods when there appear to be no occupants or everyone is asleep against the “leakage” hypothesis to determine what the apparent constant small background usage of gas, electricity and water is over long periods of time, if it is resolvable within the signal to noise capability of the measurement devices 10, 12, 14, 16;
13) the measurement data is then cleaned of this background consumption, leaving unidentified work processes;
14) the appliance recognition module 2 then attempts to resolve the electricity pattern data into lighting and other events by considering the set of appliances 7 constructed as plausibly in the building during the setup phase. This is an exercise in combinatorial mathematical searching for relatively small load appliances;
15) the appliance recognition module 2 constructs a record or a file of identified and unidentified work processes and then searches for work flows, based on the a priori Bayesian probabilities. This should identify room related activities such as using the toilet and washing hands in a bathroom or WC, cooking and using appliances in the kitchen etc. The analysis distinguishes work flows in the dark, when lighting is used, from similar daytime work flows. These two work flows are linked, but distinguished, to enable separate collection of statistics and avoid subtle differences due to time of day effects;
16) the pattern of night time work flows is examined to attempt to locate specific lumieres to rooms. Clues such as cooking, bathing, switching on appliances 7 such as washing machines, opening refrigerator doors etc. are used to develop hypotheses. For example, a freezer that is suspected to be in the garage that is part of a work flow that does not appear to use kitchen lighting but does use a light that is only used very infrequently is a very suggestive pattern. The HEMS 4 is also requested to locate other interactions such as motion sensors, humidity measurements, “touches” on fixed control pads and thermostatic radiator valves (TRVs) etc.;
17) the appliance recognition module 2 now has a set of a posteriori probability data on work flows and work processes, including autonomous work processes and work flows which probably consist of a single appliance operating in a single work process. There will also be a posteriori hypotheses, based on locational clues and clues from other occupant interactions with the HEMS 4, that some work flows represent activities of a particular occupant and others are either typical of several occupants or a team effort. For example, having a shower and drying hair tends to be a more solitary activity than cooking and eating a meal. Recognising changes in patterns of behaviour of the occupants will be important to other aspects of the HEMS 4. For example, an occupant entering the home at an unusual time of day and following a previously unknown work flow could signal an intruder and might trigger a message by the HEMS 4 to the owner. A mixture of unusual activity patterns with atypical requests to the HEMS 4 might generate a hypothesis about e.g. illness or other factors impacting on the occupants, which would be important to how the HEMS 4 interacts with them. The feedback of work flow recognition shown in FIG. 4 enables this.

During normal foreground operation the appliance recognition module 2 is matching its stock of known components from the reference data to the detailed signals available from the measurement devices 10, 12, 14, 16, using the hierarchy of appliance work processes and occupant work flows (FIG. 5) to make the disambiguation faster and more reliable. In other words, the most likely explanations/hypotheses (i.e. those having the highest probability) are tested first and are accepted if they are much more likely (i.e. by a factor of 20) than alternatives. Ambiguity may exist if there are alternative explanations, each with probability greater than e.g. 5% (although in other embodiments the threshold could be set at another level e.g. 3% or 10%). In certain embodiments, the system may look for probabilities of at least 75%, at least 80% or at least 90% and, in which case, may essentially ignore the remaining hypothesis with much lower probabilities.

The background process is started when required:
1) the first step is to rerun the process described for the end of the learning period, using previous historic data, e.g. the previous six months of historic data (although this can be varied, e.g. extended to allow for periods when the building is unoccupied). The background process attempts to identify instances of work flows, work processes and component patterns that vary significantly in their statistics from the historic data. The hypothesis will be that something has changed, so that the historic data is no longer reliable;
2) if the process was started as a result of component ambiguity, and if the historic data e.g. the last six months data fails to identify the component, then: in the case of near ambiguity (i.e. two or more components, each of which could explain the data pattern, where none is much more likely than the others), then the action will depend on the appliances 7 and energy usages involved. In the case of lighting or other small usage, then the ambiguity will be accepted for the time being and an appliance pool will be created to hold the ambiguous components for reporting and other purposes. In the case of a larger appliance or energy user, the action will be appropriate to both the appliance type and the level of engagement that the users have with their HEMS 4. For example if the component is the switch/light combination on a refrigerator and two refrigerators can be distinguished by the energy signature of their compressors, then the appliances and work processes are not ambiguous, but their disambiguation by the foreground process is more complex than recognising the switch/lamp combination. If the household has two identical refrigerators, then the only way of disambiguating them is through other clues, which may not be worth the effort. In the minority of cases where at least one user is highly engaged with the HEMS 4, then user input can be sought in addressing these issues. In principle it is the work flows that are important to the occupants; very specific recognition of the appliances is not likely to be important;
3) in the case where the component cannot be recognised as part of an appliance at all, then either there is a component that is recognisable by its generic class (e.g. a motor) but with no pattern that can be recognised as a work process, or there is apparently a component that does not fit in a class. The HEMS 4 will collect data against the component and will flag the incidence for attention by technicians supervising the central database that is shared across many HEMS 4. The background process can be flagged to be rerun after a predetermined period of time e.g. a month;
4) where the background process is triggered because a work process is unrecognised, then the HEMS 4 first attempts to find a pattern that includes other known components of the appliance 7 that is assumed to contain this component. If this is successful, the potential new work process is flagged. The background process attempts to homologate this instance of the process against the central database. A process tree can be defined describing the disambiguation of the various possibilities, for example, as shown in FIG. 10 where the appliance 7 is recognised but the work process is not plausibly associated 140, 142; the appliance 7 is recognised and the work process is related but outside parameter tolerances 144; the appliance 7 is not recognised but the process can be homologated to a process that corresponds to the class of appliances that the appliance belongs to 146; the appliance 7 has been tagged as a relatively new appliance centrally 148, and therefore may be an instance of a rare process, e.g. cleaning/defrost cycle. Once the tree is drawn and described, this section ends with a flag for the background process to be run in a predetermined time period e.g. a month;
5) where the background process is started for a reason other than the routine update, then the background process runs a complete fresh training start, using the previous information for the building as the base assumption set, but with the hypothesis that there are new occupants and/or appliances in the dwelling(s), using location related occupant and appliance data (as previously described) to moderate the a priori probabilities. Where this creates significant differences from the previous data, then the constructed data is used for work flows, work processes and components that are new. Objects that survive this process are retained but with data updated by the most recent period;
6) this data cleansing exercise completes by looking for examples of work processes where the probability from previous data of them occurring in the training period is less than a predetermined level e.g. 95%, i.e. there is a non-trivial chance they simply did not occur in the recent period. The background process checks that appliances have not been deleted (i.e. removed from the view of the foreground process) where it is possible they simply did not operate in the period. The background process retains these deleted items in case they reappear and need to be reinstated. The background process tests the hypothesis that a new appliance has replaced a deleted one. If this appears to be correct, it flags this relationship in the HEMS data log, so that it can later draw conclusions from historic data. Where the HEMS 4 has an appropriate relationship with a user and the appliance is a major one in terms of energy usage (i.e. not lighting, a handheld device etc.), then it can query the user to confirm the replacement;
7) where a significant proportion of utility use by appliance or work flow is altered in the review, then the process flags itself to rerun in a predetermined period of time e.g. month.

The processes described above will enable the ‘key’ energy signatures to be detected and analysed in order to identify one or more appliances through comparison with the expected energy signature profiles of a number of different appliances and models. These ‘key’ appliances will be washing machines, dishwashers, TVs, refrigerators, freezers, lights etc. This will leave a combination of energy signatures that are more difficult to distinguish, which may originate from smaller appliances such as device chargers, and appliances/devices that are on continuously contributing to the background signature such as burglar alarms, the HEMS 4 itself etc. Once the ‘key’ appliances have been identified or recognised, the remaining data can be analysed to identify the remaining appliances according to the same processes. The aim is to identify all appliances in the building. The identification of some appliances will be able to occur quickly, by comparison with the reference data and historical/typical usage data for the building/surrounding geographical area etc. Others may require monitoring over a longer time e.g. if an appliance is used infrequently.

For example, there may be 250 appliances/components in a house. The appliance recognition module 2/HEMS 4 aims to know what state they are in at a particular moment in time. This includes a hypothesis based on Bayesian probabilities. The most probable explanations are considered first, which will lead to a number of appliances being recognised. The remaining energy signatures are then analysed and compared with hypotheses with the aim of identifying the appliances and/or the state of those appliances. By enabling the most likely hypotheses to be searched first, this advantageously increases the chance of successful disambiguation and reduces computational requirements.

Aspects and embodiments of the invention advantageously provide for more comprehensive integration of information from sensors on utility flows into the dwelling and internal sensors to provide a better base dataset than has previously been possible. This enables understanding of patterns of occupancy within the building, of appliance and utility use, which aids consumers in managing their utilities more effectively.

Furthermore, unlike known systems, aspects and embodiments of the present invention incorporate patterns of human behaviour in using individual appliances, and combinations of appliances in recognising workflows like washing, cooking, bathing/showering etc., which facilitates appliance recognition.

An overview of the system context for a HEMS 4 in accordance with an embodiment of the present invention is illustrated in FIG. 11. This outlines some of the inputs to the HEMS 4 (and their interrelated nature) including details on the building physics 150, the external environment 152 (including weather forecasts and energy tariffs), the internal environment 154 (including location of appliances, micro-environments) and occupant experiences 156 (including relationships, patterns of occupancy/usage, costs and budgeting).

Aspects and embodiments of the invention also employ disambiguation by construction and testing of hypotheses within and across many dwellings through sophisticated algorithms. Such processes have not been possible prior to now.

It will be appreciated by persons skilled in the art that various modifications may be made to the above embodiments without departing from the scope of the present invention as defined by the claims. For example, features from one embodiment may be mixed and matched with features from other embodiments.

1. A method of operating an environment management system within a building, comprising:
monitoring appliance usage within the building by monitoring two or more utilities and measuring one or more characteristics relating to each of the utilities to provide an output signal representative thereof;
monitoring for changes in the state of each of the output signals at predefined time intervals;
combining data from the output signals from each utility, to identify one or more patterns of appliance usage;
comparing the identified pattern of appliance usage with stored patterns of appliance usage associated with individual occupants of the building to identify an expected pattern of future appliance usage; and
operating the environment management system to control the environment in the building in accordance with the identified expected pattern of future appliance usage.

2. The method according to claim 1, wherein appliances in the building constitute a system and the system is represented as a finite state machine and each output signal represents a state of a characteristic of the system at a particular time.

3. A method of operating an environment management system within a building, comprising:
monitoring appliance usage within a building, wherein appliances in the building constitute a system and the system is represented as a finite state machine;
monitoring two or more utilities and measuring one or more characteristics relating to each of the utilities to provide an output signal, each output signal representing a state of a characteristic of the system at a particular time;
monitoring for changes in the state of each of the output signals at predefined time intervals;
combining data from the output signals from each utility, to identify one or more patterns of appliance usage; and
operating the environment management system to control the environment in the building in accordance with the identified patterns.

4. The method according to claim 3, wherein the system is represented as a Markov chain.

5. The method according to claim 1, wherein the step of identifying said patterns of appliance usage comprises using a priori probabilities and firstly comparing reference patterns of appliance usage that are determined to be most likely, with the data.

6. The method according to claim 1, wherein the measurement of said one or more characteristics is recorded within a measurement bin of predetermined size, said bin being within a predetermined measurement range.

7. The method according to claim 1, further comprising defining a work process based on a pattern of inputs to an appliance over time.

8. The method according to claim 7, further comprising defining a work flow based on identifiable sequences of work processes across one or more appliances.

9. The method according to claim 8, wherein the step of identifying one or more patterns of appliance usage comprises determining a utility usage pattern for an appliance based on processing of said output signals and analysis of identified work processes and work flows.

10. The method according to claim 1, comprising comparing one or more of said patterns of appliance usage with one or more reference patterns to identify the appliance with which the output signals are associated.

11. The method according to claim 10 comprising evaluating the probability that an appliance exists within the building based on said comparison.

12. The method according to claim 1, comprising comparing one or more of said patterns of appliance usage with one or more reference patterns to infer an indication of the existence, location and/or usage of one or more appliances within said building.

13. The method according to claim 5, wherein the a priori probabilities include frequency distributions of work flows.

14. The method according to claim 13, wherein the a priori probabilities include exogenous factors and hypotheses about the occupation state of the building.

15. The method according to claim 13, further comprising modifying the a priori probabilities associated with patterns of appliance usage hypothetically arising from work flow(s), work process(es), appliance(s) and/or component(s) of appliance(s) by reference to stored data on historic appliance usage.

16. The method according to claim 15, wherein said historic appliance usage relates to one or more appliances in one or more other buildings and the a priori probabilities are determined dependent on the geographical distance of another building relative to the said building.

17. The method according to claim 1, further comprising representing one or more reference appliances in a computer language whereby the pattern of appliance usage is derived from defined processes operating on defined components within the appliance.

18. The method according to claim 17, wherein the language enables specific instances of appliances, processes and components to be created by class inheritance.

19. The method according to claim 12, wherein said reference appliance pattern is acquired from an electronic signature, barcode or Qcode present on or related to said appliance.

20. The method according to claim 11, wherein said probability is derived from a combination of analysis of central data and user input.

21. The method according to claim 1, wherein the characteristics comprise one or more of flow variables, noise variables and quality variables.

22. The method according to claim 20, wherein the characteristics comprise one or more of voltage, RMS voltage, calorific value, phase angle, power, real power, reactive power and colour.

23. An apparatus for operating an environment management system within a building, comprising:
apparatus for monitoring appliance usage within the building, comprising a plurality of measurement devices, each configured to measure one or more characteristics relating to a particular one of two or more utilities and to provide an output signal representative thereof; and
a processing device configured, in response to the combination of said output signals from each utility, to:
monitor for changes in the state of each of said output signals at predefined time intervals and combine information from a plurality of output signals to identify one or more patterns of appliance usage;
to compare the identified pattern of appliance usage with stored patterns of appliance usage associated with individual occupants of the building to identify an expected pattern of future appliance usage; and
to operate the environment management system to control the environment in the building in accordance with the identified expected pattern of future appliance usage.

24. The apparatus according to claim 23,
wherein appliances in the building constitute a system and the system is represented as a finite state machine, each output signal representing a state of a characteristic of the system at a particular time.
